(19) United States
(12) Patent Application Publication
(10) Pub. No.: US 2021/0104719 A1
(43) Pub. Date: Apr. 8, 2021

(54) BATTERY ELECTRODE AND METHOD FOR MANUFACTURING THE SAME

(71) Applicant: MURATA MANUFACTURING CO., LTD., Kyoto (JP)

(72) Inventor: Makiko OIKAWA, Kyoto (JP)

(21) Appl. No.: 16/951,149

(22) Filed: Nov. 18, 2020

Related U.S. Application Data
(63) Continuation of application No. PCT/JP2019/022407, filed on Jun. 5, 2019.

(30) Foreign Application Priority Data
Jun. 11, 2018 (JP) 2018-111371

(51) Int. Cl. H01M 4/04; H01M 4/139

(52) U.S. Cl. CPC H01M 4/0404; H01M 4/139; H01M 4/0471; H01M 4/0435

(57) ABSTRACT

There is provided a method for manufacturing a battery electrode. The method includes: forming a precursor of the battery electrode including a double-sided coating area in which both sides of a current collector are coated with an electrode material layer and a single-sided coating area adjacent to the double-sided coating area; subjecting the current collector located at a boundary portion between the double-sided coating area and the single-sided coating area to a heat treatment locally; and pressurizing the precursor of the battery electrode. The single-sided coating area includes a main side of the current collector that is coated with the electrode material layer.

### CROSS REFERENCE TO RELATED APPLICATIONS

The present application is a continuation of PCT patent application no. PCT/JP2019/022407, filed on Jun. 5, 2019, which claims priority to Japanese patent application no. JP2018-111371 filed on Jun. 11, 2018, the entire contents of which are being incorporated herein by reference.

### BACKGROUND

The present technology generally relates to a battery electrode and a method for manufacturing the battery electrode.

In recent years, there has been an increasing demand for batteries, especially rechargeable secondary batteries, for electronic devices such as personal computers and smartphones. The battery has a structure in which electrodes (a positive electrode and a negative electrode) and an electrolytic solution are provided in a housing.

Here, the battery electrode can be manufactured through at least the steps of (i) forming a precursor of the electrode by coating the main side of a current collector (metal foil) with an electrode material layer and (ii) pressurizing the precursor of the electrode using a press roll device or the like while the precursor of the electrode is moved in one direction between a pair of press rolls.

### SUMMARY

The present technology generally relates to a battery electrode and a method for manufacturing the battery electrode.

In the conventional technology, there is a possibility that the following technical problem will be caused in the case of pressurizing the precursor of the electrode 100′ including the single-sided coating area and the double-sided coating area adjacent to the single-sided coating area each other.

Specifically, in the case that the single-sided coating area and the double-sided coating area are pressurized using the pair of press rolls 40′, there is a possibility that the pressurized state of the single-sided coating area located at a boundary portion 70′ between the double-sided coating area and the single-sided coating area will be different from the pressurized state of the single-sided (or double-sided) coating area located at a portion other than the boundary portion 70′. This is because the current collector 10′ in the single-sided coating area located at the boundary portion 70′ is not easy to bring into contact with the press roll 40′ owing to the presence of the electrode material layer 30′ located at the end of the double-sided coating area (see FIGS. 4A to 4E). Therefore, there is a possibility that the pair of press rolls 40′ facing each other cannot suitably pressurize the current collector 10′ and the electrode material layer 20′ in the single-sided coating area located at the boundary portion 70′. As a result, there is a possibility that the volume density of the electrode material layer 20′ in the single-sided coating area located at the boundary portion 70′ is relatively lower than the volume density of the electrode material layers 20′ and 30′ located at the portion other than the boundary portion 70′. That is, the electrode material layer 20′ in the single-sided coating area located at the boundary portion 70′ can be a low volume density area 23′ (see the upper part of FIG. 1).

For example, in the case that the battery is a lithium ion secondary battery, the volume density of the electrode material layer is locally low in the low volume density area 23′, so that the lithium deposition state in the low volume density area 23′ is different from the lithium deposition state in another area. Furthermore, the presence of the low volume density area 23′ can be a factor of capacity deterioration and deterioration of the cycle characteristic. Furthermore, there is a possibility that when the electrodes 100′ that can include the low volume density area 23′, specifically, the positive electrode and the negative electrode are stacked with a separator interposed therebetween to obtain an electrode structure, the presence of the low volume density area 23′ causes variation in the characteristic of the electrode structure.

Therefore, an object of the present invention is to provide an electrode including a single-sided coating area and a double-sided coating area adjacent to the single-sided coating area each other, the electrode in which the range of the low volume density area of the electrode material layer in the single-sided coating area located at the boundary portion between the single-sided coating area and the double-sided coating area can be reduced, and to provide a method for manufacturing the electrode.

According to an embodiment of the present disclosure, a battery electrode is provided. The battery electrode includes:

a double-sided coating area including a current collector and an electrode material layer with which both sides of the current collector are coated; and a single-sided coating area. adjacent to the double-sided coating area, wherein the single-sided coating area includes the current collector and the electrode material layer with which a side of the current collector is coated,

wherein the current collector located at a boundary portion between the double-sided coating area and the single-sided coating area has a Young's modulus lower than a Young's modulus of the current collector located at a portion other than the boundary portion.

According to an embodiment of the present disclosure, a method for manufacturing a battery electrode is provided.

The method includes:

forming a precursor of the battery electrode including a double-sided coating area in which both sides of a current collector are coated with an electrode material layer and a single-sided coating area adjacent to the double-sided coating area, wherein the single-sided coating area includes a main side of the current collector that is coated with the electrode material layer;

subjecting the current collector located at a boundary portion between the double-sided coating area and the single-sided coating area to a heat treatment locally; and

pressurizing the precursor of the battery electrode.

According to an embodiment of the present disclosure, in the case of a battery electrode including a single-sided coating area and a double-sided coating area adjacent to the single-sided coating area each other, it is possible to suitably reduce the range of the low volume density area of the electrode material layer in the single-sided coating area located at the boundary portion between the single-sided coating area and the double-sided coating area.

The effect described in the present description is merely an example and is not restrictive, and an additional effect may be provided.

### BRIEF DESCRIPTION OF THE FIGURES

FIG. 1 is a schematic sectional view in which an aspect of pressurization of a precursor of a conventional electrode and an aspect of pressurization of a precursor of an electrode according to an embodiment of the present technology are compared.

FIG. 2 is a schematic view of an aspect in which a current collector located at a boundary portion is subjected to a heat treatment using a high-frequency induction heating device according to an embodiment of the present technology.

FIG. 3A and FIG. 3B are graphs in which Examples 1 and 2 according to an embodiment of the present disclosure are compared with a comparative example (conventional example).

FIG. 4A is a schematic view showing a conventional technical problem.

FIG. 4B is a schematic sectional view showing an aspect of pressurizing a single-sided coating area located at a portion other than a boundary portion between a double-sided coating area and the single-sided coating area according to an embodiment of the present technology.

FIG. 4C is a schematic sectional view showing an aspect of pressurizing the single-sided coating area located at the portion other than the boundary portion between the double-sided coating area and the single-sided coating area after a lapse of a predetermined time from the aspect in FIG. 4B according to an embodiment of the present technology.

FIG. 4D is a schematic sectional view showing an aspect of pressurizing the single-sided coating area located at the boundary portion between the double-sided coating area and the single-sided coating area after a lapse of a predetermined time from the aspect in FIG. 4C according to an embodiment of the present technology.

FIG. 4E is a schematic sectional view showing an aspect of pressurizing the double-sided coating area after a lapse of a predetermined time from the aspect in FIG. 4D according to an embodiment of the present technology.

FIG. 5 is a schematic sectional view of a secondary battery according to an embodiment of the present technology.

FIG. 6 is a schematic partial sectional view of a wound electrode structure in a secondary battery according to an embodiment of the present technology.

FIG. 7 is a schematic exploded perspective view of a laminated film-shaped square lithium ion secondary battery according to an embodiment of the present technology.

FIG. 8A is a schematic exploded perspective view of a laminated film-shaped lithium ion secondary battery of an aspect different from that shown in FIG. 7 according to an embodiment of the present technology.

FIG. 8B is a schematic sectional view of the electrode structure in the laminated film-shaped lithium ion secondary battery taken along the arrow A-A in FIG. 7 and FIG. 8A.

FIG. 9 is a schematic exploded perspective view of an application example (battery pack unit cell) of a lithium ion secondary battery including a laminated structure according to an embodiment of the present technology.

FIG. 10A is a block diagram showing a configuration of an application example (electric vehicle) of a lithium ion secondary battery including a laminated structure according to an embodiment of the present technology.

FIG. 10B is a block diagram showing a configuration of an application example (power storage system) of a lithium ion secondary battery including a laminated structure according to an embodiment of the present technology.

FIG. 10C is a block diagram showing a configuration of an application example (electric tool) of a lithium ion secondary battery including a laminated structure according to an embodiment of the present technology.

### DETAILED DESCRIPTION

As described herein, the present disclosure will be described based on examples with reference to the drawings, but the present disclosure is not to be considered limited to the examples, and various numerical values and materials in the examples are considered by way of example.

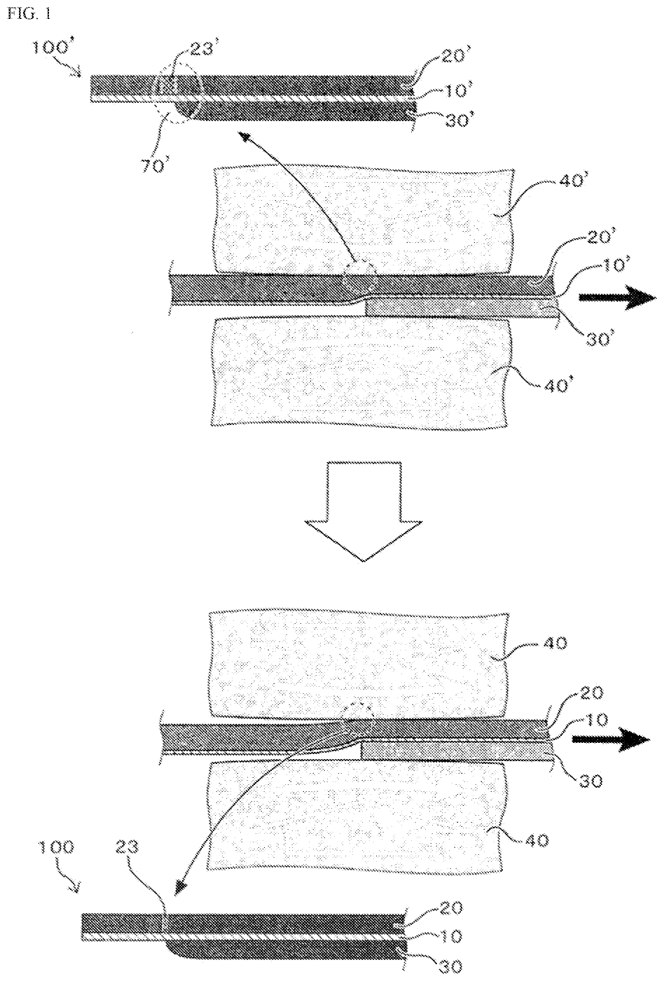

First, the method for manufacturing the battery electrode according to one embodiment of the present invention will be described (see the lower part of FIG. 1).

As described above, the present inventors focused on the technical problem that in the case of a battery electrode including a single-sided coating area and a double-sided coating area adjacent to the single-sided coating area each other, the volume density of the electrode material layer is reduced in the single-sided coating area located at the boundary portion between the single-sided coating area and the double-sided coating area. Specifically, the present inventors focused on the technical problem that the reduction in the volume density of the electrode material layer is directly caused by the fact that “the current collector in the single-sided coating area located at the boundary portion is not easy to suitably bring into contact with a press roll owing to the presence of the electrode material layer located at, the end of the double-sided coating area”.

As a result, in order to suitably solve such a technical problem, the present inventors have come up with a method for manufacturing a battery based on the following technical concept.

The method for manufacturing a battery electrode according to the present invention is based on a technical concept of “subjecting a current collector 10 to a heat treatment locally at a boundary portion 70 between the double-sided coating area and the single-sided coating area and thereafter pressurizing a precursor of an electrode 100”. According to the technical concept of the present invention, the timing of the local heat treatment of the current collector 10 located at the boundary portion 70 may be after the main side of the current collector 10 is coated with an electrode material layer 20 (that is, after the precursor of the electrode 100 is formed), or may be before the main side of the current collector 10 is coated with the electrode material layer 20. In the latter aspect, the state before the main side of the current collector 10 is coated with the electrode material layer 20 can be a state in which the current collector 10 is present and no electrode material layer is present. Therefore, in the latter aspect, from the viewpoint of an efficient heat treatment, it is preferable that the portion to be the boundary portion 70 be previously grasped and then the current collector 10 located at the boundary portion 70 be subjected to the local heat treatment. The term “boundary portion” used in the present description refers to a portion in which the change from the double-sided coating area to the single-sided coating area occurs, or the change from the single-sided coating area to the double-sided coating area occurs. The term “heat treatment” used in the present description refers to a treatment of applying thermal energy to a current collector in a broad sense. The term “heat treatment” used in the present description refers to, in a narrow sense, a treatment to improve ductility by applying thermal energy to a current collector to remove the strain inside the current collector and soften the current collector. From this point of view, the “heat treatment” can also be referred to as “annealing treatment”. The term “precursor of an electrode” used in the present description refers to a precursor including a double-sided coating area in which both sides of a current collector are coated with an electrode material layer and including a single-sided coating area adjacent to the double-sided coating area each other, the single-sided coating area in which one main side of the current collector is coated with the electrode material layer.

According to such a technical concept, a local portion of the current collector 10 can be softened because thermal energy is applied to the portion that is located at the boundary portion 70 between the double-sided coating area and the single-sided coating area and is subjected to the heat treatment. Therefore, by the heat treatment, the Young's modulus of the current collector 10 located at the boundary portion 70 can be reduced to be lower than the Young's modulus of the current collector 10 located at the portion other than the boundary portion 70. Particularly because the electrode material layer 20 is located on the upper side of the current collector 10 in the single-sided coating area located at the boundary portion 70, the weight of the electrode material layer 20 can act on the current collector 10. Therefore, the heat-treated current collector 10 in the single-sided coating area located at the boundary portion 70 can be gently curved downward.

As a result, when the precursor of the electrode 100 is pressurized using a pair of press rolls 40 later, the current collector 10 in the single-sided coating area located at the boundary portion 70 and the press roll 40 can come into contact with each other in a range increased to be larger than in the conventional case that the heat treatment is not performed. From the viewpoint of suitably increasing the range in which the current collector 10 in the single-sided coating area located at the boundary portion 70 and the press roll 40 can come into contact with each other, the Young's modulus of the current collector 10 located at the boundary portion 70 is preferably reduced to be 50% or more lower than the Young's modulus of the current collector located at the portion other than the boundary portion 70.

As a result, it is possible to increase the range in which the pair of press rolls 40 facing each other can suitably pressurize the current collector 10 and the electrode material layer 20 in the single-sided coating area located at the boundary portion 70. Therefore, it is possible to reduce the range of a low volume density area 23 of the electrode material layer 20 in the single-sided coating area located at the boundary portion 70. In other words, it is possible to increase the range of the electrode material layer 20 having a high volume density in the single-sided coating area located at the boundary portion 70.

As a result, it is possible to reduce the difference between the volume density of the electrode material layer in the coating area located at the boundary portion 70 and the volume density of the electrode material layer located at the portion other than the boundary portion. Specifically, the ratio of the volume density of the electrode material layer located at the boundary portion (A) to the volume density of the electrode material layer located at the portion other than the boundary portion (B) (A/B) can be 0.9 or more and 1.0 or less. Therefore, even in the case that the electrode includes the single-sided coating area and the double-sided coating area adjacent to the single-sided coating area each other, the electrode material layer having a reduced range of the low volume density area 23 can be suitably formed as a whole. As a result, the electrode can suitably function as a constituent element of a battery.

As described above, it is possible to reduce the of the low volume density area of the electrode material layer as a whole. Therefore, in the case that the battery is a lithium ion secondary battery, it is possible to suitably suppress the possibility that the lithium deposition state in the boundary portion will be different from the lithium deposition state in the portion other than the boundary portion. Furthermore, the range of the low volume density area can be reduced as a whole, and therefore, it is possible to reduce the capacity deterioration and the deterioration of the cycle characteristic. Furthermore, it is possible to reduce the range of the low volume density area of the electrode material layer that is a constituent element of the electrode. Therefore, when the electrodes (the positive electrode and the negative electrode) are stacked with a separator interposed therebetween to obtain an electrode structure, it is also possible to suitably suppress the variation in the characteristic of the electrode structure.

In one embodiment, the method for manufacturing the electrode according to the present invention preferably adopts the following aspect.

In one aspect, the current collector 10 and the electrode material layers 20 and 30 located at the boundary portion 70 are preferably subjected to a non-contact heat treatment.

In the method for manufacturing according to the present invention, from the viewpoint of making the shape of the current collector located at the boundary portion easier to deform than the shape of the current collector located at the portion other than the boundary portion, the current collector located at the boundary portion is subjected to the heat treatment. Here, the current collector and the electrode material layer that are the constituent elements of the electrode can affect the battery characteristic. Therefore, for example, if the current collector and the electrode material layer in the single-sided coating area located at the boundary portion are heated while brought into direct contact with a heating device, there is a possibility that, the current collector and the electrode material layer will be broken due to the direct contact.

Therefore, the current collector and the electrode material layer located at the boundary portion are preferably subjected to, not a heat treatment by direct contact, but a non-contact heat treatment. As an example, the non-contact heat treatment is preferably performed using a high-frequency induction heating device 80. In the high-frequency induction heating device 80, for example, when a body to be heated is positioned in a coil-shaped member connected to an AC power source, a high-density eddy current is generated due to the alternating current near the surface of the body, and the surface of the body is heated by the Joule heat by the current. Using such a device, when the current collector 10 (and the electrode material layer) is positioned in the coil-shaped member connected to the AC power source, a high-density eddy current is generated due to the alternating current near the surface of the current collector 10 (and the electrode material layer), and the surface of the current collector (and the electrode material layer) can be heated by the Joule heat by the current.

The high-frequency induction heating device is preferably driven when the high-frequency induction heating device 80 faces the current collector 10 located at the boundary portion 70 each other. The boundary portion 70 between the double-sided coating area and the single-sided coating area can be formed at a regular interval. Therefore, it is unnecessary to continuously heat the precursor of the electrode using the high-frequency induction heating device. Therefore, in the case that the precursor of the electrode is moved in one direction and the high-frequency induction heating device (in particular, the coil-shaped member) is positioned at a predetermined position prior to the press roll in order to heat the current collector at the boundary portion, the high-frequency induction heating device is preferable driven when the coil-shaped member of the device and the current collector located at the boundary portion face each other. As a result, the high-frequency induction heating device 80 can be used only when necessary, and heating of the current collector or the like in the portion other than the boundary portion 70 can be suitably avoided.

Hereinafter, the battery electrode according to one embodiment of the present invention will be described.

The battery electrode 100 according to the present invention can be obtained through the above-described method for manufacturing according to the present invention. The battery electrode according to the present invention can particularly have the following feature. Specifically, as described above, a local portion of the current collector 10 can be softened because thermal energy is applied to the portion that is located at the boundary portion 70 between the double-sided coating area and the single-sided coating area and is subjected to the heat treatment. Therefore, the shape of the current collector 10 located at the boundary portion 70 is easier to deform than in the case that the current collector is not subjected to the heat treatment. In one aspect, from the viewpoint of suitably increasing the range in which the current collector 10 in the single-sided coating area located at the boundary portion 70 and the press roll 40 can come into contact with each other, the Young's modulus of the current collector 10 located at the boundary portion 70 is reduced to be 50% or more lower than the Young's modulus of the current collector 10 located at the portion other than the boundary portion 70. The property and the shape of the once deformed current collector located at the boundary portion 70 are not restored even after the pressurization treatment. This means that even in the battery electrode according to the present invention obtained after the pressurization treatment, the Young's modulus of the current collector 10 at the boundary portion 70 is reduced to be relatively lower than the Young's modulus of the current collector 10 located at the portion other than the boundary portion 70.

As described above, in the present invention, it is possible to increase the range in which the pair of press rolls 40 facing each other can suitably pressurize the current collector 10 and the electrode material layer 20 in the single-sided coating area located at the boundary portion 70. Therefore, in the electrode according to the present invention obtained after the pressurization, it is possible to reduce the range of the low volume density area 23 of the electrode material layer 20 in the single-sided coating area located at the boundary portion 70. In one aspect, it is possible to reduce the range of the low volume density area 23 of the electrode material layer in the single-sided coating area located at the boundary portion 70 to be 50% or more lower than in the case that the heat, treatment is not performed at the boundary portion 70. As a result, it is possible to reduce the difference between the volume density of the electrode material layer 20 in the coating area located at the boundary portion 70 and the volume density of the electrode material layer 20 located at the portion other than the boundary portion 70. Specifically, the ratio of the volume density of the electrode material layer located at the boundary portion (A) to the volume density of the electrode material layer located at the portion other than the boundary portion (B) (A/B) can be 0.9 or more and 1.0 or less. From the above, even in the case that the electrode includes the single-sided coating area and the double-sided coating area adjacent to the single-sided coating area each other, the electrode material layer having a reduced range of the low volume density area 23 can be suitably formed as a whole.

Hereinafter, the constituent element in the case of using the battery according to the present invention as a lithium ion secondary battery will be described for confirmation.

In a lithium ion secondary battery, during the charge, for example, lithium ions are released from the positive electrode material (positive electrode active material) and absorbed into the negative electrode active material via the non-aqueous electrolytic solution. Furthermore, during the discharge, for example, lithium ions are released from the negative electrode active material and absorbed into the positive electrode material (positive electrode active material) via the non-aqueous electrolytic solution.

The member included in the lithium ion secondary battery is housed in the electrode structure housing member (battery can). Examples of the member included in the lithium ion secondary battery include a positive electrode, a negative electrode, an electrolyte, and a separator. The positive electrode includes, for example, a positive electrode current collector and a positive electrode material layer. The negative electrode includes, for example, a negative electrode current collector and a negative electrode material layer. Furthermore, a positive electrode lead portion is attached to the positive electrode current collector, and a negative electrode lead portion is attached to the negative electrode current collector.

The positive electrode material layer including the positive electrode active material is formed on the main side of the positive electrode current collector included in the positive electrode. Examples of the material included in the positive electrode current collector include conductive materials such as aluminum, nickel, and stainless steel. As the positive electrode active material, a positive electrode material capable of absorbing and releasing lithium is included. The positive electrode material layer may further include a positive electrode binder, a positive electrode conductive agent, and the like. Examples of the positive electrode material include lithium-containing compounds, and from the viewpoint of obtaining a high energy density, lithium-containing composite oxides and lithium-containing phosphoric acid compounds are preferably used. The lithium-containing composite oxides are oxides containing lithium and one or two or more elements (hereinafter, referred to as “other elements”, however, lithium is excluded) as constituent elements, and have a layered rock salt crystal structure or a spinet crystal structure. The lithium-containing phosphoric acid compounds are phosphoric acid compounds containing lithium and one or two or more elements (other elements) as constituent elements, and have an olivine crystal structure.

The negative electrode material layer including the negative electrode active material is formed on the main side of the negative electrode current collector included in the negative electrode. Examples of the material included in the negative electrode current collector include conductive materials such as copper, nickel, and stainless steel. As the negative electrode active material, a negative electrode material capable of absorbing and releasing lithium is included. The negative electrode material layer may further include a negative electrode binder, a negative electrode conductive agent, and the like. The negative electrode binder and the negative electrode conductive agent can be the same as the positive electrode binder and the positive electrode conductive agent.

The electrode structure including the positive electrode, the separator, and the negative electrode may be in a state in which the positive electrode, the separator, the negative electrode, and the separator are wound, or in a state in which the positive electrode, the separator, the negative electrode, and the separator are stacked. The electrode structure can have a form of, in the wound state, being housed in the electrode structure housing member. Furthermore, the electrode structure can have a form of, in the stacked state, being housed in the electrode structure housing member. In these cases, the electrode structure housing member can have a form having an outer shape cylindrical or square (flat plate-shaped). Examples of the form of the lithium ion secondary battery include a coin shape, a button shape, a disk shape, a flat plate shape, a square shape, a cylindrical shape, and a laminate shape (laminated film shape).

Examples of the material of the electrode structure housing member (battery can) included in the cylindrical secondary battery include iron (Fe), nickel (Ni), aluminum (Al), titanium (Ti), alloys of these metals, and stainless steel (SUS). The battery can is preferably plated with, for example, nickel in order to prevent electrochemical corrosion due to the charge and discharge of the secondary battery. The exterior member of the laminate-shaped (laminated film-shaped) secondary battery preferably has a form having a laminated structure with a plastic material layer (fusion layer), a metal layer, and a plastic material layer (surface protective layer), that is, a form of a laminated film. In the case of the laminated film-shaped secondary battery, for example, the exterior member is folded so that the fusion layers face each other with the electrode structure interposed therebetween, and then peripheries of the fusion layers are fused to each other. However, the exterior member may be one in which two laminated films are bonded together via an adhesive agent or the like. The fusion layer includes, for example, a film of an olefin resin such as polyethylene, polypropylene, modified polyethylene, modified polypropylene, or a polymer thereof. The metal layer includes, for example, an aluminum foil, a stainless steel foil, or a nickel foil. The surface protective layer includes, for example, nylon or polyethylene terephthalate. In particular, the exterior member is preferably an aluminum laminated film in which a polyethylene film, an aluminum foil, and a nylon film are stacked in this order. However, the exterior member may be a laminated film having another laminated structure, may be a film of a polymer such as polypropylene, or may be a metal film.

Hereinafter, in the case of a battery including a lithium ion secondary battery, the positive electrode member, the negative electrode member, the positive electrode mixture layer, the positive electrode active material, the negative electrode mixture layer, the negative electrode active material, the binder, the conductive agent, the separator, and the non-aqueous electrolytic solution that are included in the lithium ion secondary battery will be described.

In the positive electrode member, the positive electrode mixture layer including the positive electrode active material is formed on both the sides of the positive electrode current collector. That is, the positive electrode mixture layer includes a positive electrode material, as the positive electrode active material, capable of absorbing and releasing lithium. The positive electrode mixture layer may further include a positive electrode binder, a positive electrode conductive agent, and the like. Examples of the material included in the positive electrode current collector include copper (Cu), aluminum (Al), nickel (Ni), magnesium (Mg), titanium (Ti), iron (Fe), cobalt (Co), zinc (Zn), germanium (Ge), indium (In), gold (Au), platinum (Pt), silver (Ag), palladium (Pd), alloys containing any of these materials, and conductive materials such as stainless steel. Examples of the form of the positive electrode current collector or the negative electrode current collector described below include foil-like materials.

Examples of the positive electrode material include lithium-containing compounds, and from the viewpoint of obtaining a high energy density, lithium-containing composite oxides and lithium-containing phosphoric acid compounds are preferably used. The lithium-containing composite oxides are oxides containing lithium and one or two or more elements (hereinafter, referred to as “other elements”, however, lithium is excluded) as constituent elements, and have a layered rock salt crystal structure or a spinel crystal structure. The lithium-containing phosphoric acid compounds are phosphoric acid compounds containing lithium and one or two or more elements (other elements) as constituent elements, and have an olivine crystal structure.

The details of the lithium-containing composite oxide and the lithium-containing phosphoric acid compound that are preferable materials included in the positive electrode material are as follows. Other elements included in the lithium-containing composite oxide and the lithium-containing phosphoric acid compound are not particularly limited, and examples of the elements include any one or two or more of the elements belonging to Groups 2 to 15 in the long periodic table. From the viewpoint of obtaining a high voltage, nickel <Ni>, cobalt <Co>, manganese <Mn>, and iron <Fe> are preferably used.

Specific examples of the lithium-containing composite oxide having a layered rock salt crystal structure include compounds represented by Formulae (B), (C), and (D).

LiₐMn_{1-b-c}Ni_{b}M_{11c}O_{2-d}Fₑ (B)

M₁₁ is at least one element selected from the group consisting of cobalt <Co>, magnesium <Mg>, aluminum <Al>, boron <B>, titanium <Ti>, vanadium <V>, chromium <Cr>, iron <Fe>, copper <Cu>, zinc <Zn>, zirconium <Zr>, molybdenum <Mo>, tin <Sn>, calcium <Ca>, strontium <Sr>, and tungsten <W>, and the values of a, b, c, d, and e satisfy

0.8≤a≤1.2,

0<b<0.5,

0≤c≤0.5,

b+c<1,

−0.1≤d≤0.2, and

0≤e≤0.1. However, the composition differs depending on the charge/discharge state, and a is the value in the completely discharged state.

LiₐNi_{1-b}M_{12b}O_{2-c}F_{d} (C)

M₁₂ is at least one element selected from the group consisting of cobalt <Co>, manganese <Mn>, magnesium <Mg>, aluminum <Al>, boron <B>, titanium <Ti>, vanadium <V>, chromium <Cr>, iron <Fe>, copper <Cu>, zinc <Zn>, molybdenum <Mo>, tin <Sn>, calcium <Ca>, strontium <Sr>, and tungsten <W>, and the values of a, b, c, and d satisfy

0.8≤a≤1.2,

0.005'b≤0.5,

−0.1≤c≤0.2, and

0≤d≤0.1. However, the composition differs depending on the charge/discharge state, and a is the value in the completely discharged state.

LiₐCo_{1-b}M_{13b}O_{2-c}F_{d} (D)

M₁₃ is at least one element selected from the group consisting of nickel <Ni>, manganese <Mn>, magnesium <Mg>, aluminum <Al>, boron <B>, titanium <Ti>, vanadium <V>, chromium <Cr>, iron <Fe>, copper <Cu>, zinc <Zn>, molybdenum <Mo>, tin <Sn>, calcium <Ca>, strontium <Sr>, and tungsten <W>, and the values of a, b, c, and d satisfy

0.8≤a≤1.2,

0≤b<0.5,

−0.1≤c≤0.2, and

0≤d≤0.1. However, the composition differs depending on the charge/discharge state, and a is the value in the completely discharged state.

Specific examples of the lithium-containing composite oxide having a layered rock salt crystal structure include LiNiO₂, LiCoO₂, LiCo_{0.98}Al_{0.01}Mg_{0.01}O₂, LiNi_{0.5}Co_{0.02}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})_{0.85}O₂. Specific examples of the LiNiMnO-based material include LiNi_{0.5}Mn_{1.50}O₄.

For example, in the case of obtaining Li_{1.15}(Mn_{0.65}Ni_{0.22}Co_{0.13})_{0.85}O₂ as the positive electrode active material, first, nickel sulfate (NiSO₄), cobalt sulfate (CoSO₄), and manganese sulfate (MnSO₄) are mixed. Then, the mixture is dispersed in water to prepare an aqueous solution. Next, while the aqueous solution is sufficiently stirred, sodium hydroxide (NaOH) is added to the aqueous solution to obtain a coprecipitate (rnanganese-nickel-cobalt composite coprecipitated hydroxide). Then, the coprecipitate is washed with water and dried, and then lithium hydroxide monohydrate is added to the coprecipitate to obtain a precursor. Then, the precursor is fired in the atmosphere (800° C.×10 hours) to obtain the above-described positive electrode active material.

For example, in the case of obtaining LiNi_{0.5}Mn_{1.50}O₄ as the positive electrode active material, first, lithium carbonate (Li₂CO₃), manganese oxide (MnO₂), and nickel oxide (NiO) are weighed, and the weighed materials are mixed using a ball mill. In this case, the mixing ratio (molar ratio) of the main elements is Ni:Mn=25:75. Next, the mixture is fired in the atmosphere (800° C.×10 hours) and then cooled. Next, the fired product is remixed using a ball mill and then refired in the atmosphere (700° C.×10 hours) to obtain the above-described positive electrode active material.

Examples of the lithium-containing composite oxide having a spinel crystal structure include compounds represented by Formula (E).

LiₐMn_{2-b}M_{14b}O_{c}F_{d} (E)

M₁₄ is at least one element selected from the group consisting of cobalt <Co>, nickel <Ni>, magnesium <Mg>, aluminum <Al>, boron <B>, titanium <Ti>, vanadium <V>, chromium <Cr>, iron <Fe>, copper <Cu>, zinc <Zn>, molybdenum <Mo>, tin <Sn>, calcium <Ca>, strontium <Sr>, and tungsten <W>, and the values of a, b, c, and d satisfy

0.9≤a≤1.1,

0≤b≤0.6,

3.7≤c≤4.1, and

0≤d≤0.1. However, the composition differs depending on the charge/discharge state, and a is the value in the completely discharged state. Specific examples of the lithium-containing composite oxide having a spinel crystal structure include LiMn₂O₄.

Examples of the lithium-containing phosphoric acid compound having an olivine crystal structure include compounds represented by Formula (F).

LiₐM₁₅PO₄ (F)

M₁₅ is at least one element selected from the group consisting of cobalt <Co>, manganese <Mn>, iron <Fe>, nickel <Ni>, magnesium <Mg>, aluminum <Al>, boron <B>, titanium <Ti>, vanadium <V>, niobium <Nb>, copper <Cu>, zinc <Zn>, molybdenum <Mo>, calcium <Ca>, strontium <Sr>, tungsten <W>, and zirconium <Zr>, and the value of a satisfies

0.9≤a≤1.1. However, the composition differs depending on charge/discharge state, and a is the value in the completely discharged state. Specific examples of the lithium-containing phosphoric acid compound having an olivine crystal structure include LiFePO₄, LiMnPO₄, LiFe_{0.5}Mn_{0.5}PO₄, and LiFe_{0.3}Mn_{0.7}PO₄.

Furthermore, examples of the lithium-containing composite oxide include compounds represented by Formula (G).

(Li₂MnO₃)ₓ(LiMnO₂)₁₋ₓ (G)

The value of x satisfies

0≤x≤1. However, the composition differs depending on the charge/discharge state, and x is the value in the completely discharged state.

The positive electrode may also include, for example, oxides such as titanium oxide, vanadium oxide, and manganese dioxide; disulfides such as titanium disulfide and molybdenum sulfide; chalcogenides such as niobium selenide; and conductive polymers such as sulfur, polyaniline, and polythiophene.

In the negative electrode member, the negative electrode mixture layer is formed on both the sides of the negative electrode current collector.

Examples of the material included in the negative electrode current collector include copper (Cu), aluminum (Al), nickel (Ni), magnesium (Mg), titanium (Ti), iron (Fe), cobalt (Co), zinc (Ln), germanium (Ge), indium (In), gold (Au), platinum (Pt), silver (Ag), palladium (Pd), alloys containing any of these materials, and conductive materials such as stainless steel. The surface of the negative electrode current collector is preferably roughened from the viewpoint of improving the adhesion of the negative electrode mixture layer to the negative electrode current collector owing to the so-called anchor effect. In this case, the surface of the negative electrode current collector needs to be roughened at least at the area on which the negative electrode mixture layer is to be formed. Examples of the method of the roughening include a method in which fine particles are formed by an electrolytic treatment. The electrolytic treatment is a method in which fine particles are formed on the surface of the negative electrode current collector in an electrolytic cell by an electrolytic method to make the surface of the negative current collector uneven. Alternatively, the negative electrode member can include a lithium foil, a lithium sheet, or a lithium plate. The negative electrode mixture layer includes a negative electrode material, as the negative electrode active material, capable of absorbing and releasing lithium. The negative electrode mixture layer may further include a negative electrode binder, a negative electrode conductive agent, and the like. The negative electrode binder and the negative electrode conductive agent can be the same as the positive electrode binder and the positive electrode conductive agent.

Examples of the material included in the negative electrode active material include carbon materials. Because the change in the crystal structure is very little during the absorbing and releasing of lithium in the carbon material, a high energy density is stably obtained. Furthermore, because the carbon material also functions as a negative electrode conductive agent, the conductivity of the negative electrode mixture is improved. Examples of the carbon material include graphitizable carbon (soft carbon), non-graphitizable carbon (hard carbon), graphite, and highly crystalline carbon materials having a developed crystal structure. However, the non-graphitizable carbon preferably has a plane spacing of the (002) plane of 0.37 nm or more, and the graphite preferably has a plane spacing of the (002) plane of 0.34 nm or less. More specific examples of the carbon material include thermally decomposed carbon; coke such as pitch coke, needle coke, and petroleum coke; graphite; glassy carbon fibers; organic polymer compound fired products obtained by firing (carbonizing) a polymer compound such as a phenol resin or a furan resin at an appropriate temperature; carbon fibers; activated carbon; carbon blacks; and polymers such as polyacetylene. In addition, low crystalline carbon heat-treated at a temperature of about 1,000° C. or less, and amorphous carbon can be used as the carbon material. The shape of the carbon material may be fibrous, spherical, granular, or flaky.

Furthermore, examples of the material included in the negative electrode active material include materials containing one or two or more metal elements or metalloid elements as a constituent element (hereinafter, referred to as “metal-based materials”), and a high energy density can be obtained due to such a material. The metal-based material may be a simple substance, an alloy, or a compound, or may be a material including two or more kinds thereof, or a material having one or two or more of these phases at least partially. Examples of the alloy include a material including two or more metal elements, and in addition, a material containing one or more metal elements and one or more metalloid elements. The alloy may also contain a non-metallic element. Examples of the constitution of the metal-based material include a solid solution, a eutectic (eutectic mixture), an intermetallic compound, and a composition in which two or more of these constitutions coexist.

Examples of the metal element and the metalloid element include metal elements and metalloid elements capable of forming an alloy with lithium. Specific examples include magnesium (Mg), boron (B), aluminum (Al), gallium (Ga), indium (In), silicon (Si), germanium (Ge), tin (Sn), lead (Ph), antimony (Sb), bismuth (Bi), cadmium (Cd), silver (Ag), zinc (Zn), hafnium (Hf), zirconium (Zr), yttrium (Y), palladium (Pd), and platinum (Pt), and among these elements, silicon (Si) and tin (Sn) are preferable from the viewpoints that they have excellent ability to absorb and release lithium and that a remarkably high energy density can be obtained.

Examples of the material containing silicon as a constituent element include an elemental silicon, silicon alloys, and silicon compounds. The material containing silicon as a constituent element may be a material including two or more kinds thereof, or a material having one or two or more of these phases at least partially. Examples of the material containing tin as a constituent element include an elemental tin, tin alloys, and tin compounds. The material containing tin as a constituent element may be a material including two or more kinds thereof, or a material having one or two or more of these phases at least partially. The term “simple substance” refers to a simple substance in a general sense. The simple substance may contain a small amount of an impurity, and is not necessarily a substance having a purity of 100%.

Examples of the element, other than silicon, included in the silicon alloy or the silicon compound include tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), chromium (Cr), carbon (C), and oxygen (O).

Specific examples of the silicon alloy and the silicon compound include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v<2, preferably 0.2<v<1.4), and LiSiO.

Examples of the element, other than tin, included in the tin alloy or the tin compound include silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), chromium (Cr), carbon (C), and oxygen (O). Specific examples of the tin alloy and the tin compound include SnO_{w} (0<w≤2), SnSiO₃, LiSnO. and Mg₂Sn. In particular, the material containing tin as a constituent element is preferably, for example, a material containing tin (first constituent element) and also containing a second constituent element and a third constituent element (hereinafter, referred to as “Sn-containing material”). Examples of the second constituent element include cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cesium (Ce), hafnium (Hf), tantalum (Ta), tungsten (W), bismuth (Bi), and silicon (Si), and examples of the third constituent element include boron (B), carbon (C), aluminum (Al), and phosphorus (P). If the Sn-containing material contains the second constituent element and the third constituent element, a high battery capacity and an excellent cycle characteristic is obtained.

In particular, the Sn-containing material is preferably a material containing tin (Sn), cobalt (Co), and carbon (C) as constituent elements (referred to as “SnCoC-containing material”). In the SnCoC-containing material, the content of carbon is 9.9% by mass to 29.7% by mass, and the ratio of the contents of tin and cobalt {Co/(Sn+Co)} is 20% by mass to 70% by mass. This is because a high energy density can be obtained. The SnCoC-containing material has a phase containing tin, cobalt, and carbon, and the phase is preferably low crystalline or amorphous.

Because this phase is a reaction phase capable of reacting with lithium, an excellent characteristic is obtained due to the presence of the reaction phase. The diffraction peak obtained by X-ray diffraction of the reaction phase preferably has a half width (diffraction angle 2θ) of 1 degree or more in the case that a CuKα ray is used as the specific X-ray and the insertion speed is 1 degree/min. This is because lithium is absorbed and released more smoothly and because the reactivity with the non-aqueous electrolytic solution is reduced. The SnCoC-containing material sometimes includes a phase containing the constituent elements or a part of the constituent elements in addition to the low crystalline or amorphous phase.

Whether the diffraction peak obtained by X-ray diffraction corresponds to the reaction phase capable of reacting with lithium can be easily determined by comparing the X-ray diffraction charts before and after the electrochemical reaction with lithium. For example, if the position of the diffraction peak changes before and after the electrochemical reaction with lithium, the diffraction peak corresponds to the reaction phase capable of reacting with lithium. In this case, for example, the diffraction peak of the low crystalline or amorphous reaction phase is observed from 2θ=20 degrees to 50 degrees. Such a reaction phase contains, for example, each constituent element described above, and is considered to be low-crystallized or amorphized mainly owing to the presence of carbon.

In the SnCoC-containing material, at least a part of the carbon being a constituent element is preferably bonded to the metal element or the metalloid element. This is because the aggregation and the crystallization of tin and the like are suppressed. The bonding state of the elements can be confirmed by, for example, X-ray photoelectron spectroscopy (XPS) using an Al-Kα ray, an Mg-Kα ray, or the like as a soft X-ray source. In the case that at least a part of the carbon is bonded to the metal element or the metalloid element, the peak of the synthetic wave in the 1 s orbital of carbon (C1s) appears in a region lower than 284.5 eV Note that the energy calibration is performed so that the peak in the 4f orbital of a gold atom (Au4f) is obtained at 84.0 eV. At this time, because surface contamination carbon is usually present on the surface of the substance, the C1s peak of the surface contamination carbon is set to 284.8 eV, and the peak is used as the energy reference. In the XPS measurement, the waveform of the C1s peak is obtained in a form including the peak of the surface contamination carbon and the peak of the carbon in the SnCoC-containing material. Therefore, for example, analysis may be performed using commercially available software to separate the two peaks. In the waveform analysis, the position of the main peak present in the lowest binding energy side is used as the energy reference (284.8 eV).

The SnCoC-containing material is not limited to a material whose constituent elements are only tin, cobalt, and carbon (SnCoC). The SnCoC-containing material may contain, for example, one or two or more of silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), bismuth (Bi), and the like as a constituent element in addition to tin, cobalt, and carbon.

In addition to the SnCoC-containing material, a material containing tin, cobalt, iron, and carbon as constituent elements (hereinafter, referred to as “SnCoFeC-containing material”) is also a preferable material. The composition of the SnCoFeC-containing material is arbitrary, For example, in the case that the iron content is set to be small, the carbon content is 9.9% by mass to 29.7% by mass, the iron content is 0.3% by mass to 5.9% by mass, and the ratio of the contents of tin and cobalt {Co/(Sn+Co)} is 30% by mass to 70% by mass.

In the case that the iron content is set to be large, the carbon content is 11.9% by mass to 29.7% by mass, the ratio of the contents of tin, cobalt, and iron {(Co+Fe)/(Sn+Co+Fe)} is 26.4% by mass to 48.5% by mass, and the ratio of the contents of cobalt and iron {Co/(Co+Fe)} is 9.9% by mass to 79.5% by mass. This is because a high energy density is obtained in such a composition range. The physical property (such as half width) of the SnCoFeC-containing material is the same as that of the SnCoC-containing material described above.

Furthermore, examples of another material included in the negative electrode active material include metal oxides such as iron oxide, ruthenium oxide, and molybdenum oxide; and. polymer compounds such as polyacetylene, polyaniline, and polypyrrole.

In particular, the material included in the negative electrode active material preferably contains both the carbon material and the metal-based material for the following reason. The metal-based material, particularly a material containing at least one of silicon or tin as a constituent element, has an advantage of having a high theoretical capacity, but tends to expand and contract extremely during the charge and discharge.

Meanwhile, the carbon material has a low theoretical capacity, but has an advantage of rarely expanding and rarely contracting during the charge and discharge. Therefore, by using both the carbon material and the metal-based material, the expansion and the contraction during the charge and discharge are suppressed while a high theoretical capacity (in other words, battery capacity) is obtained.

The positive electrode mixture layer and the negative electrode mixture layer can be formed by, for example, a coating method. That is, the positive electrode mixture layer and the negative electrode mixture layer can be formed by a method in which a positive electrode active material or a negative electrode active material in a form of particles (powder) is mixed with a positive electrode binder, a negative electrode binder, or the like, then the mixture is dispersed in a solvent such as an organic solvent, and the dispersion is applied to a positive electrode current collector or a negative electrode current collector (for example, a coating method in which a coating device provided with a die and a back roll described above is used). However, the coating method is not limited to such a method, and the method of forming the positive electrode mixture layer and the negative electrode mixture layer is not limited to the coating method. For example, a negative electrode member can be obtained by molding a negative electrode active material, and a positive electrode member can be obtained by molding a positive electrode active material. The molding may be performed using, for example, a press machine. Furthermore, the positive electrode mixture layer and the negative electrode mixture layer can be formed by a vapor phase method, a liquid phase method, a thermal spraying method, or a firing method (sintering method). The term “vapor phase method” refers to physical vapor deposition methods (PVD methods) such as a vacuum deposition method, a sputtering method, an ion plating method, and a laser ablation method, and various chemical vapor deposition methods (CVD methods) such as a plasma CVD method. Examples of the liquid phase method include an electrolytic plating method and an electroless plating method. The thermal spraying method is a method in which a molten or semi-molten positive electrode active material or negative electrode active material is sprayed onto a positive electrode current collector or a negative electrode current collector. The firing method is, for example, a method in which a mixture dispersed in a solvent is applied to a negative electrode current collector by a coating method, and then the resulting product is heat-treated at a temperature higher than the melting point of a negative electrode binder or the like, and examples of the firing method include an atmosphere firing method, a reaction firing method, and a hot press firing method.

Specific examples of the positive electrode binder and the negative electrode binder include synthetic rubbers such as styrene butadiene-based rubbers such as a styrene butadiene rubber (SBR), fluorine-based rubbers, and ethylene propylene diene; fluorine-based resins such as polyvinylidene fluoride (PVdF), polyvinyl fluoride, polyimides, polytetrafluoroethylene (PTFE), and ethylene tetrafluoroethylene (ETFE), and copolymers and modified products of these fluorine-based resins; polyolefin-based resins such as polyethylene and polypropylene; acrylic-based resins such as polyacrylonitrile (PAN) and polyacrylic acid esters; and polymer materials such as carboxymethyl cellulose (CMC), and in addition, at least one selected from copolymers and the like mainly including these resin materials. More specific examples of the copolymer of polyvinylidene fluoride include polyvinylidene fluoride-hexafluoropropylene copolymers, polyvinylidene fluoride-tetrafluoroethylene copolymers, polyvinylidene fluoride-chlorotrifluoroethylene copolymers, and polyvinylidene fluoride-hexafluoropropylene-tetrafluoroethylene copolymers. Furthermore, a conductive polymer may be used as the positive electrode binder and the negative electrode binder. As the conductive polymer, for example, substituted or unsubstituted polyaniline, poly pyrrole, polythiophene, and a (co)polymer including one or two selected from these polymers can be used.

Examples of the positive electrode conductive agent and the negative electrode conductive agent include carbon materials such as graphite, carbon fibers, carbon blacks, carbon nanotubes, graphite, vapor growth carbon fibers (VGCFs), acetylene black (AB), and Ketjen black (KB), and one or two or more of these carbon materials can be mixed and used. Examples of the carbon nanotube include multi-wall carbon nanotubes (MWCNTs) such as single-wall carbon nanotubes (SWCNTs) and double-wall carbon nanotubes (DWCNTs).

Furthermore, a metal material, a conductive polymer material, or the like may be used as long as it is a conductive material.

In order to prevent lithium from being unintentionally deposited on the negative electrode member during the charge, the chargeable capacity of the negative electrode material is preferably larger than the discharge capacity of the positive electrode material. That is, the electrochemical equivalent of the negative electrode material capable of absorbing and releasing lithium is preferably larger than the electrochemical equivalent of the positive electrode material. Note that the lithium deposited on the negative electrode member is, for example, a lithium metal in the case that the electrode reactant is lithium.

The positive electrode lead portion can be attached to the positive electrode current collector by spot welding or ultrasonic welding. The positive electrode lead portion is preferably a metal foil or a mesh, but does not need to be a metal as long as it is electrochemically and chemically stable and conductive. Examples of the material of the positive electrode lead portion include aluminum (Al) and nickel (Ni). The negative electrode lead portion can be attached to the negative electrode current collector by spot welding or ultrasonic welding. The negative electrode lead portion is preferably a metal foil or a mesh, but does not need to be a metal as long as it is electrochemically and chemically stable and conductive. Examples of the material of the negative electrode lead portion include copper (Cu) and nickel (Ni).

The positive electrode lead portion or the negative electrode lead portion can be formed using a protruding portion in which a part of the positive electrode current collector or the negative electrode current collector protrudes from the positive electrode current collector or the negative electrode current collector.

The separator separates the positive electrode member and the negative electrode member, and allows lithium ions to pass through the separator while a short circuit of a current is prevented from being caused by contact between the positive electrode member and the negative electrode member. The separator includes, for example, a porous film including a synthetic resin such as a polyolefin-based resin (a polypropylene resin or a polyethylene resin), a polyimide resin, a polytetrafluoroethylene resin, a polyvinylidene fluoride resin, a polyphenylene sulfide resin, or an aromatic polyamide; a porous film including a ceramic or the like; a glass fiber (such as a glass filter); a nonwoven fabric including a liquid crystal polyester fiber, an aromatic polyamide fiber, or a cellulose-based fiber, or a nonwoven fabric including a ceramic. Among the materials, the porous film including polypropylene or polyethylene is preferable. Furthermore, the separator can include a laminated film in which two or more kinds of porous films are stacked, or can be a separator coated with an inorganic substance layer or a separator containing an inorganic substance. Among the materials, the porous film including a polyolefin-based resin is preferable because the porous film provides an excellent effect of preventing short circuit and can improve battery safety by the shutdown effect. The polyethylene resin is particularly preferable as a material included in the separator because the polyethylene resin can provide the shutdown effect in the range of 100° C. or more and 160° C. or less and also has excellent electrochemical stability. In addition, a material produced by copolymerizing or blending a resin having chemical stability with polyethylene or polypropylene can be used. The porous film may have, for example, a structure of three or more layers in which a polypropylene resin layer, a polyethylene resin layer, and a polypropylene resin layer are stacked in order. The separator preferably has a thickness of 5 μm or more and 50 μm or less, and more preferably 7 μm or more and 30 μm or less. If the separator is too thick, the filling amount of the active material is reduced, and as a result, the battery capacity and the ionic conductivity are reduced to deteriorate the current characteristic. If the separator is too thin, the mechanical strength of the separator is reduced.

Furthermore, the separator may have a structure in which a resin layer is provided on one side or both sides of the porous film being a substrate. Examples of the resin layer include porous matrix resin layers on which an inorganic substance is supported. By employing such a structure, oxidation resistance can be obtained to suppress the deterioration of the separator. Examples of the material included in the matrix resin layer include polyvinylidene fluoride (PVdF), hexafluoropropylene (HFP), and polytetrafluoroethylene (PTFE), and copolymers thereof can also be used. Examples of the inorganic substance include metals, semiconductors, and oxides and nitrides thereof. Examples of the metal include aluminum (Al) and titanium (Ti), and examples of the semiconductor include silicon (Si) and boron (B). The inorganic substance preferably has substantially no conductivity and has a large heat capacity. The inorganic substance having a large heat capacity is useful as a heat sink at the time of current heat generation, and makes it possible to suppress the thermal runaway of the battery further effectively. Examples of the inorganic substance include oxides and nitrides such as alumina (Al₂O₃), boehmite (alumina monohydrate), talc, boron nitride (BN), aluminum nitride (AlN), titanium dioxide (TiO₂), and silicon oxide.

The inorganic substance has a particle size of, for example, 1 nm to 10 μm. If the particle size is less than 1 nm, the inorganic substance is difficult to obtain, and is not worth the cost of obtaining it. If the particle size is more than 10 μm, the distance between the electrodes is large, and a sufficient filling amount of the active material cannot be obtained in the limited space, resulting in a low battery capacity. The inorganic substance may be contained in the porous film being a substrate. The resin layer can be obtained by, for example, a method in which a slurry including a matrix resin, a solvent, and an inorganic substance is applied to a substrate (porous film), the resulting product is passed through a bath of a solvent that is a poor solvent of the matrix resin and a solvophilic solvent of the solvent for phase separation, and then dried.

The separator has a puncture strength of, for example, 100 gf to 1 kgf, and preferably 100 gf to 480 gf. If the puncture strength is low, there is a possibility that a short circuit will be caused, and if the puncture strength is high, there is a possibility that the ionic conductivity will be reduced. The separator has an air permeability of, for example, 30 seconds/100 cc to 1,000 seconds/100 cc, and preferably 30 seconds/100 cc to 680 seconds/100 cc. If the air permeability is too low, there is a possibility that a short circuit will be caused, and if the air permeability is too high, there is a possibility that the ionic conductivity will be reduced.

Examples of the lithium salt included in a non-aqueous electrolytic solution suitable for use in a lithium ion secondary battery include LiPF₆, LiClO₄, LiBF₄, LiAsF₆, LiSbF₆, LiTaF₆, LiNbF₆, LiSiF₆, LiAlCl₄, LiCF₃SO₃, LiCH₃SO₃, LiCH₃SO₃, LiN(CF₃SO₂)₂, LiC(CF₃SO₂)₃, LiC₄F₉SO₃, Li(FSO₂)₂N, Li(CF₃SO₂)₂N, Li(C₂F₅SO₂)₂N, Li(CF₃SO₂)₃C, LiBF₃(C₂F₅), LiB(C₂O₄)₂, LiB(C₆F₅)₄, LiPF₃(C₂F₅)₃, ½Li₂B₁₂F₁₂, Li₂SiF₆, LiCl, LiBr, LiI, difluoro[oxalato-O,O′]borate, and lithium bis(oxalate)borate, but are not limited thereto.

As the organic solvent, cyclic carbonates such as ethylene carbonate (EC), propylene carbonate (PC), and butylene carbonate (BC) can be used, and it is preferable to use one of ethylene carbonate or propylene carbonate, and more preferable to mix and use both of them so that the cycle characteristic can be improved. From the viewpoint of obtaining high ionic conductivity, the cyclic carbonate can be mixed with a chain carbonate such as diethyl carbonate, dimethyl carbonate, ethyl methyl carbonate, or methyl propyl carbonate and used as the solvent. The solvent may also contain 2,4-difluoroanisole or vinylene carbonate, 2,4-Difluoroanisole can improve the discharge capacity, and vinylene carbonate can improve the cycle characteristic. Therefore, it is preferable to mix and use these components because the discharge capacity and the cycle characteristic can be improved.

Furthermore, examples of the organic solvent include chain carbonates such as dimethyl carbonate (DMC), ethyl methyl carbonate (EMC), diethyl carbonate (DEC), dipropyl carbonate (DPC), propyl methyl carbonate (PMC), propyl ethyl carbonate (PEC), and fluoroethylene carbonate (FEC); cyclic ethers such as mrahydrofuran (THF), 2-methyltetrahydrofuran (2-MeTHF), 1,3-dioxolane (DOL), and 4-methyl-1,3-dioxolane (4-MeDOL), chain ethers such as 1,2-dimethoxyethane (DME) and 1,2-diethoxyethane (DEE); cyclic esters such as γ-butyrolactone (GBL) and γ-valerolactone (GNI); and chain esters such as methyl acetate, ethyl acetate, propyl acetate, methyl formate, ethyl formate, propyl formate, methyl butyrate, methyl propionate, ethyl propionate, and propyl propionate. Furthermore, examples of the organic solvent include tetrahydropyran, 1,3-dioxane, 1,4-dioxane, N,N-dimethylformamide (DMF), N,N-dimethylacetoamide (DMA), N-methylpyrrolidirione (NMP), N-methyloxazolidinone (NMO), N,N′-dimethylimidazolidinone (DMI), dimethyl sulfoxide (DMSO), trimethylphosphate (IMP), nitromethane (NM), nitroethane (NE), sulfolane (SL), methylsulfolane, acetonitrile (AN), anisole, propionitrile, glutaronitrile (GLN), adiponitrile (ADN), methoxyacetonitrile (MAN), 3-methoxypropionitrile (MPN), diethyl ether, butylene carbonate, 3-methoxypropionitrile, N,N-dimethylformamide, dimethyl sulfoxide, and trimethyl phosphate. Furthermore, ionic liquids can also be used as the organic solvent. Known ionic liquids can be used, and an ionic liquid may be selected as needed.

The electrolyte layer can be formed using the non-aqueous electrolytic solution and a holding polymer compound. The non-aqueous electrolytic solution is held by, for example, the holding polymer compound. The electrolyte layer in such a form is a gel-like electrolyte or a solid electrolyte in which high ionic conductivity (for example, 1 mS/cm or more at room temperature) is obtained, and the non-aqueous electrolytic solution is prevented from leaking. The electrolyte can be a liquid-based electrolyte, a gel-like electrolyte, or a solid electrolyte. The gel-like electrolyte is advantageous in terms of productivity in manufacturing a lithium ion battery having a large area because a vacuum injection process of the electrolytic solution is not necessary, and because a continuous application process can be employed.

Specific examples of the holding polymer compound include polyacrylonitrile, polyvinylidene fluoride, polytetrafluoroethylene, polyhexafluoropropylene, polyethylene oxide, polypropylene oxide, polyphosphazene, polysiloxane, polyvinyl fluoride (PVF), polychlorotrifluoroethylene (PCTFE), a perfluoroalkoxy fluororesin (PFA), ethylene tetrafluoride-propylene hexafluoride copolymers (FEPs), ethylene-ethylene tetrafluoride copolymers (ETFEs), ethylene-chlorotrifluoroethylene copolymers (ECTFEs), polyvinyl acetate, polyvinyl alcohol, polymethyl methacrylate, polyacrylic acid, polymethacrylic acid, a styrene-butadiene rubber, a nitrile-butadiene rubber, polystyrene, polycarbonate, polyethylene oxide, and vinyl chloride. These compounds may be used singly or may be mixed and used. The holding polymer compound may be a copolymer. Specific examples of the copolymer include polyvinylidene fluoride-hexafluoropropylene copolymers, and among the copolymers, polyvinylidene fluoride is preferable as the homopolymer, and polyvinylidene fluoride-hexafluoropropylene copolymers are preferable as the copolymer from the viewpoint of electrochemical stability. Furthermore, a compound having high heat resistance such as Al₂O₃, SiO₂, TiO₂, or BN (boron nitride) may be included as a filler.

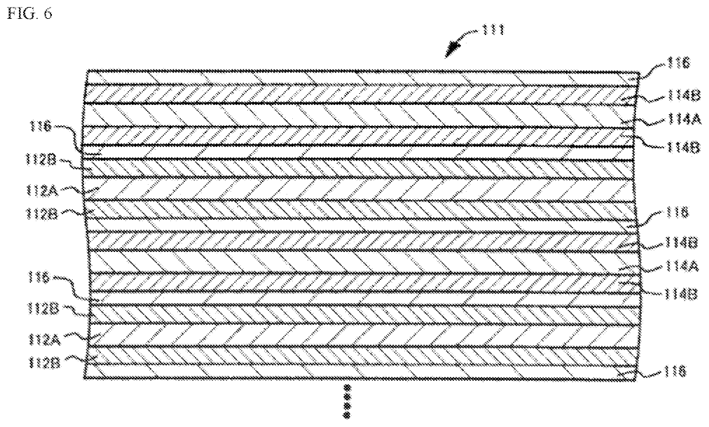

Hereinafter, a lithium ion secondary battery having a form of a cylindrical lithium ion secondary battery will be described. FIG. 5 shows a schematic sectional view of a cylindrical lithium ion secondary battery. FIG. 6 shows a schematic partial sectional view along the longitudinal axis of an electrode structure that forms a lithium ion secondary battery. Here, FIG. 6 is a schematic partial sectional view of a portion where the positive electrode lead portion and the negative electrode lead portion are not placed, and shows the electrode structure in a flat view for simplification of the drawing, but in reality, the electrode structure is curved because it is wound.

In the lithium ion secondary battery, an electrode structure 111 and a pair of insulating plates 102 and 103 are housed inside an electrode structure housing member 101 having a substantially hollow columnar shape. The electrode structure 111 can be prepared by, for example, stacking a positive electrode member 112 and a negative electrode member 114 with a separator 116 interposed therebetween to obtain an electrode structure, and then winding the electrode structure.

The electrode structure housing member (battery can) 101 has a hollow structure in which one end is closed and the other end is open, and is prepared from iron (Fe), aluminum (Al), or the like. The surface of the electrode structure housing member 101 may be plated with nickel (Ni) or the like. The pair of insulating plates 102 and 103 sandwich the electrode structure 111 and are placed so as to extend perpendicularly to the peripheral surface of the wound electrode structure 111. A battery lid 104, a safety valve mechanism 105, and a heat-sensitive resistance element (positive temperature coefficient element, PTC element) 106 are crimped to the open end of the electrode structure housing member 101 via a gasket 107 to seal the electrode structure housing member 101. The battery lid 104 is prepared from, for example, the same material as the electrode structure housing member 101. The safety valve mechanism 105 and the heat-sensitive resistance element 106 are provided inside the battery lid 104, and the safety valve mechanism 105 is electrically connected to the battery lid 104 via the heat-sensitive resistance element 106. In the safety valve mechanism 105, the disc plate 105A is reversed when the internal pressure is a certain value or more owing to an internal short circuit, heating from the outside, or the like. As a result, the electrical connection between the battery lid 104 and the electrode structure 111 is cut off. The resistance of the heat-sensitive resistance element 106 increases in response to the temperature rise to prevent abnormal heat generation due to a large current. The gasket 107 is prepared from, for example, an insulating material. The surface of the gasket 107 may be coated with asphalt or the like.

A center pin 108 is inserted at the winding center of the electrode structure 111. However, the center pin 108 does not need to be inserted at the winding center. A positive electrode lead portion 113 prepared from a conductive material such as aluminum is connected to the positive electrode member 112. Specifically, the positive electrode lead portion 113 is attached to a positive electrode current collector 112A. A negative electrode lead portion 115 prepared from a conductive material such as copper is connected to the negative electrode member 114. Specifically, the negative electrode lead portion 115 is attached to a negative electrode current collector 114A. The negative electrode lead portion 115 is welded to the electrode structure housing member 101 and is electrically connected to the electrode structure housing member 101. The positive electrode lead portion 113 is welded to the safety valve mechanism 105 and is electrically connected to the battery lid 104. In the example shown in FIG, 5, the negative electrode lead portion 115 is provided at one location (the outermost peripheral portion of the wound electrode structure), but in some cases, the negative electrode lead portion 115 is provided at two locations (the outermost peripheral portion and the innermost peripheral portion of the wound electrode structure).

The electrode structure 111 includes the positive electrode member 112 in which a positive electrode material layer 112B is formed on the positive electrode current collector 112A, and the negative electrode member 114 in which a negative electrode mixture layer 114B is formed on the negative electrode current collector 114A that are stacked with the separator 116 interposed therebetween. The positive electrode mixture layer 112B is not formed in the area of the positive electrode current collector 112A to which the positive electrode lead portion 113 is attached, and the negative electrode mixture layer 114B is not formed in the area of the negative electrode current collector 114A to which the negative electrode lead portion 115 is attached.

The specifications of the lithium ion secondary battery are exemplified in the table below.

Positive electrode current collector 112A Aluminum foil having thickness of 20 μm

Positive electrode mixture layer 112B Thickness: 50 μm per side

Positive electrode lead portion 113 Aluminum (Al) foil having thickness of 100 μm

Negative electrode current collector 114A Copper foil having thickness of 20 μm

Negative electrode mixture layer 114B Thickness: 50 μm per side

Negative electrode lead portion 115 Nickel (Ni) foil having thickness of 100 μm

The positive electrode member 112 can be prepared by the following method. First, lithium carbonate (Li₂CO₃) and cobalt carbonate (CoCO₃) are mixed, and then the mixture is fired in air (900° C.×5 hours) to obtain a lithium-containing composite oxide (LiCoO₂). In this case, the mixing ratio is a molar ratio of, for example, Li₂CO₃:CoO₃=0.5:1. Then, 91 parts by mass of a positive electrode active material (LiₓCoO₂), 3 parts by mass of a positive electrode binder (polyvinylidene fluoride), and 6 parts by mass of a positive electrode conductive agent (graphite) are mixed to prepare a positive electrode mixture. Then, the positive electrode mixture is mixed with an organic solvent (N-methyl-2-pyrrolidone) to obtain a paste-like positive electrode mixture slurry. Next, the positive electrode mixture slurry is applied to both sides of the strip-shaped positive electrode current collector 112A (corresponding to a substrate and including an aluminum foil having a thickness of 20 μm) using a coating device, and then the positive electrode mixture slurry is dried to form a laminated structure (positive electrode mixture layer 112B) described in each of Examples 1 to 3. Then, the first layer and the second layer (positive electrode mixture layer 112B) of the laminated structure are pressed(pressurized and compressed) by the method described in each of Examples 1 to 3 using the roll press machine described in each of Examples 1 to 3.

When the negative electrode member 114 is prepared, first, 97 parts by mass of a negative electrode active material (graphite or a mixed material of graphite and silicon) and 3 parts by mass of a negative electrode binder (polyvinylidene fluoride) are mixed to obtain a negative electrode mixture. The graphite has an average particle size d₅₀ of 20 μm. As the negative electrode binder, for example, a mixture of 1.5 parts by mass of an acrylic modified product of a styrene-butadiene copolymer and 1.5 parts by mass of carboxymethyl cellulose is alternatively used. Then, the negative electrode mixture is mixed with an organic solvent (N-methyl-2-pyrrolidone) to obtain a paste-like negative electrode mixture slurry. Next, the negative electrode mixture slurry is applied to both sides of a strip-shaped negative electrode current collector 114A using a coating device, and then dried to form a negative electrode material layer 114B. Then, the negative electrode material layer 114B is pressed (pressurized and compressed) using a roll press machine.

The separator 116 includes a microporous polyethylene film having a thickness of 20 μm. The electrode structure 111 is impregnated with a non-aqueous electrolytic solution having the composition shown in the following table. The term “solvent of the non-aqueous electrolytic solution” means a broad concept including not only a liquid material but also a material having ionic conductivity capable of dissociating an electrolyte salt. Therefore, in the case of using a polymer compound having ionic conductivity, the polymer compound is also included in the solvent.

Organic solvent: EC/PC mass ratio of 1/1

Lithium salt included in non-aqueous electrolytic solution: LiPF₆ 1.0 mol/l kg of organic solvent

Another additive Vinylene carbonate (VC) 1% by mass

Organic solvent: EC/DMC mass ratio of 3/5

Lithium salt included in non-aqueous electrolytic solution LiPF₆ 1.0 mol/l kg of organic solvent

Organic solvent: EC/DMC/FEC

mass ratio of 2.7/6.3/1.0

Lithium salt included in non-aqueous electrolytic solution : LiPF₆ 1.0 mol/l kg of organic solvent

When the non-aqueous electrolytic solution is prepared, a first compound, a second compound, a third compound, and another material are mixed and stirred. As the first compound, bisfluorosulfonylimide lithium (LiFSI) or bistrifluoromethylsulfonylimide lithium (LiTFSI) is used. As the second compound, acetonitrile (AN), propionitrile (PN), or butyronitrile (BN), which is a non-oxygen-containing mononitrile compound, or methoxyacetonitrile (MAN), which is an oxygen-containing mononitrile compound, is used. As the third compound, vinylene carbonate (VC), vinyl ethylene carbonate (VEC), or methylene ethylene carbonate (MEC), which is an unsaturated cyclic carbonate, 4-fluoro-1,3-dioxolan-2-one (FEC) or bis(fluoromethyl) carbonate (DFDMC), which is a halogenated carbonate, or succinonitrile (SN), which is a polynitrile compound, is used. As another material, ethylene carbonate (EC), which is a cyclic carbonate, dimethyl carbonate (DMC), which is a chain carbonate, or lithium hexafluorophosphate (LiPF₆) or lithium tetrafluoroborate (LiBF₄), which is an electrolyte salt, is used. However, the composition of the electrolytic solution is not limited thereto.

The lithium ion secondary battery can be manufactured in accordance with, for example, the following procedure.

First, as described above, a positive electrode material layer 112B is formed on a positive electrode current collector 112A, and a negative electrode material layer 114B is formed on a negative electrode current collector 114A.

Then, a positive electrode lead portion 113 is attached to the positive electrode current collector 112A by a welding method or the like. Furthermore, a negative electrode lead portion 115 is attached to the negative electrode current collector 114A by a welding method or the like. Next, a positive electrode member 112 and a negative electrode member 114 are stacked with a separator 116 including a microporous polyethylene film having a thickness of 20 μm interposed between the members, and the resulting laminate is wound (more specifically, the electrode structure including the positive electrode member 112/the separator 116/the negative electrode member 114/the separator 116 is wound) to prepare an electrode structure 111, and then a protective tape (not shown) is attached to the outermost peripheral portion. Then, a center pin 108 is inserted into the center of the electrode structure 111. Next, the electrode structure 111 is housed inside an electrode structure housing member (battery can) 101 while sandwiched between a pair of insulating plates 102 and 103. in this case, the tip of the positive electrode lead portion 113 is attached to a safety valve mechanism 105, and the tip of the negative electrode lead portion 115 is attached to the electrode structure housing member 101 by a welding method or the like. Then, an organic electrolytic solution or a non-aqueous electrolytic solution is injected by a reduced pressure method to impregnate the separator 116 with the organic electrolytic solution or the non-aqueous electrolytic solution. Next, a battery lid 104, the safety valve mechanism 105, and a heat-sensitive resistance element 106 are crimped to the open end of the electrode structure housing member 101 via a gasket 107.

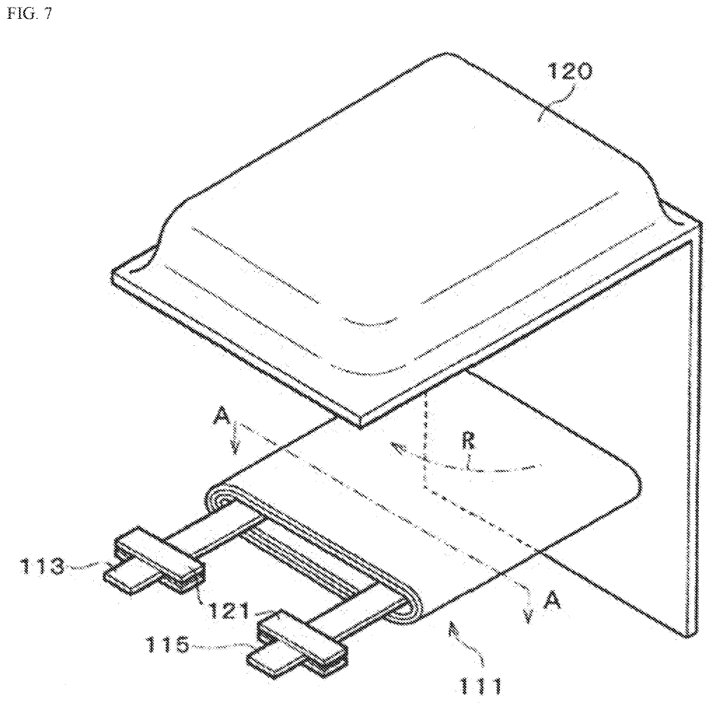

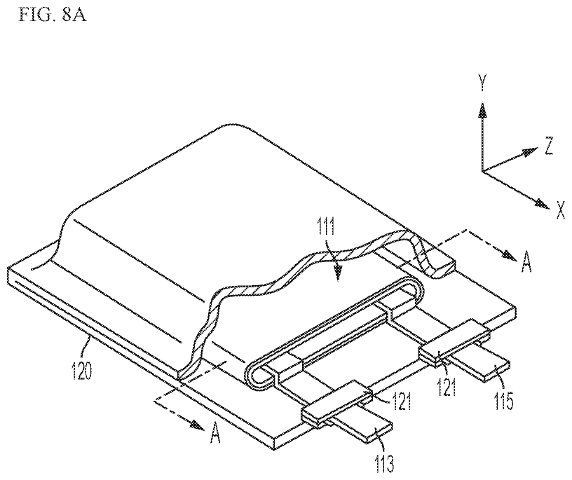

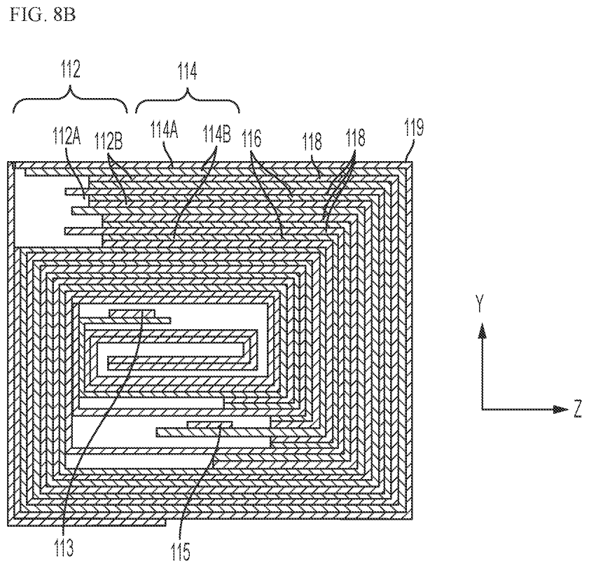

Hereinafter, a lithium ion secondary battery having a form of a laminate-shaped lithium ion secondary battery will be described. The lithium ion secondary battery has a form of a laminated film-shaped lithium ion secondary battery having a flat plate shape in which a positive electrode member, a separator, and a negative electrode member are wound. FIGS. 7 and 8A show a schematic exploded perspective view of the secondary battery, and FIG. 8B shows a schematic enlarged sectional view of the electrode structure taken along the arrow AA shown in FIGS. 7 and 8A (schematic enlarged sectional view taken along the YZ plane). FIG. 8B shows the schematic partial sectional view in which the view of a part of the electrode structure is enlarged (schematic partial sectional view taken along the XY plane) in the same manner as in FIG. 6.

In the secondary battery, an electrode structure 111 is housed inside an exterior member 120 including a laminated film. The electrode structure 111 can be prepared by stacking a positive electrode member 112 and a negative electrode member 114 with a separator 116 and an electrolyte layer 118 interposed the members, and then winding the laminated structure. A positive electrode lead portion 113 is attached to the positive electrode member 112, and a negative electrode lead portion 115 is attached to the negative electrode member 114. The outermost peripheral portion of the electrode structure 111 is protected by a protective tape 119.

The positive electrode lead portion 113 and the negative electrode lead portion 115 protrude in the same direction from the inside to the outside of the exterior member 120. The positive electrode lead portion 113 includes a conductive material such as aluminum. The negative electrode lead portion 115 includes a conductive material such as copper, nickel, or stainless steel. These conductive materials have a shape of, for example, a thin plate or a mesh.

The exterior member 120 is a single film that can be folded in the direction of the arrow R shown in FIG. 7, and a part of the exterior member 120 is provided with a recess (emboss) to house the electrode structure 111. The exterior member 120 is, for example, a laminated film in which a fusion layer, a metal layer, and a surface protective layer are stacked in this order. In the manufacturing process of the lithium ion secondary battery, the exterior member 120 is folded so that the fusion layers face each other with the electrode structure 111 interposed therebetween, and then peripheries of the fusion layers are fused to each other. However, the exterior member 120 may be one in which two laminated films are bonded together via an adhesive agent or the like. The fusion layer includes, for example, a polyethylene film or a polypropylene film. The metal layer includes, for example, an aluminum foil. The surface protective layer includes, for example, nylon or polyethylene terephthalate. In particular, the exterior member 120 is preferably an aluminum laminated film in which a polyethylene film, an aluminum foil, and a nylon film are stacked in this order. However, the exterior member 120 may be a laminated film having another laminated structure, may be a film of a polymer such as polypropylene, or may be a metal film. Specifically, the exterior member 120 includes a moisture-resistant aluminum laminated film (total thickness: 100 μm) in which a nylon film (thickness: 30 μm), an aluminum foil (thickness: 40 μm), and an unstretched polypropylene film (thickness: 30 μm) are stacked in this order from the outside.

In order to prevent intrusion of outside air, an adhesive film 121 is inserted between the exterior member 120 and the positive electrode lead portion 113, and between the exterior member 120 and the negative electrode lead portion 115. The adhesive film 121 includes a material having adhesion to the positive electrode lead portion 113 and the negative electrode lead portion 115, such as a polyolefin resin, more specifically, such as a polyolefin resin such as polyethylene, polypropylene, modified polyethylene, or modified polypropylene.

As shown in FIG. 8B, the positive electrode member 112 has a positive electrode mixture layer 112B on both sides of a positive electrode current collector 112A. The negative electrode member 114 has a negative electrode mixture layer 114B on both sides of a negative electrode current collector 114A.

The electrolyte layer contains the non-aqueous electrolytic solution and the holding polymer compound, and can have a configuration in which the non-aqueous electrolytic solution is held by the holding polymer compound. Such an electrolyte layer is a gel-like electrolyte in which high ionic conductivity (for example, 1 mS/cm or more at room temperature) is obtained, and the non-aqueous electrolytic solution is prevented from leaking. The electrolyte layer may further contain another material such as an additive.

In the electrolyte layer that is a gel-like electrolyte, the term “solvent of the non-aqueous electrolytic solution” means a broad concept including not only a liquid material but also a material having ionic conductivity capable of dissociating an electrolyte salt. Therefore, in the case of using a polymer compound having ionic conductivity, the polymer compound is also included in the solvent. Instead of the gel-like electrolyte layer, the non-aqueous electrolytic solution may be used as it is. In this case, the electrode structure is impregnated with the non-aqueous electrolytic solution.

Specifically, when the electrolyte layer is formed, first, a non-aqueous electrolytic solution is prepared.

Then, the non-aqueous electrolytic solution, a holding polymer compound, and an organic solvent (dimethyl carbonate) are mixed to prepare a sol-like precursor solution. As the holding polymer compound, a copolymer of hexafluoropropylene and vinylidene fluoride (copolymerization amount of hexafluoropropylene=6.9% by mass) is used. Next, the precursor solution is applied to a positive electrode member and a negative electrode member, and then the precursor solution is dried to form a gel-like electrolyte laver.

The lithium ion secondary battery including the gel-like electrolyte layer can be manufactured in accordance with, for example, the following three procedures.

In a first procedure, first, a positive electrode mixture layer 112B is formed on both sides of a positive electrode current collector 112A, and a negative electrode mixture layer 114B is formed on both sides of a negative electrode current collector 114A. A non-aqueous electrolytic solution, a holding polymer compound, and an organic solvent are mixed to prepare a sol-like precursor solution. Next, the precursor solution is applied to a positive electrode member 112 and a negative electrode member 114, and then the precursor solution is dried to form a gel-like electrolyte layer. Then, a positive electrode lead portion 113 is attached to the positive electrode current collector 112A, and a negative electrode lead portion 115 is attached to the negative electrode current collector 114A by a welding method or the like. Next, the positive electrode member 112 and the negative electrode member 114 are stacked with a separator 116 including a microporous polypropylene film interposed between the members, and the resulting laminate is wound to prepare an electrode structure 111, and then a protective tape 119 is attached to the outermost peripheral portion. Then, an exterior member 120 is folded so as to sandwich the electrode structure 111, and then peripheries of the exterior member 120 are adhered to each other by a heat fusion method or the like to enclose the electrode structure 111 in the exterior member 120. An adhesive film (acid-modified propylene film) 121 is inserted between the positive electrode lead portion 113 and the exterior member 120 and between the negative electrode lead portion 115 and the exterior member 120.

In a second procedure, first, a positive electrode member 112 and a negative electrode member 114 are prepared. Then, a positive electrode lead portion 113 is attached to the positive electrode member 12, and a negative electrode lead portion 115 is attached to the negative electrode member 114. Next, the positive electrode member 112 and the negative electrode member 114 are stacked with a separator 116 interposed between the members, and the resulting laminate is wound to prepare a wound body being a precursor of an electrode structure 111, and then a protective tape 119 is attached to the outermost peripheral portion of the wound body. Next, an exterior member 120 is folded so as to sandwich the wound body, and then the peripheries of the exterior member 120 are adhered to each other excluding peripheries of one side of the exterior member 120 by a heat fusion method or the like to house the wound body inside the bag,-shaped exterior member 120. A non-aqueous electrolytic solution, a monomer that is a raw material of a polymer compound, a polymerization initiator, and, if necessary, another material such as a polymerization inhibitor are mixed to prepare a composition for an electrolyte. Next, the composition for an electrolyte is injected into the bag-shaped exterior member 120, and then the exterior member 120 is sealed by a heat fusion method or the like. Then, the monomer is thermally polymerized to form a polymer compound. As a result, a gel-like electrolyte layer is formed.

In a third procedure, a wound body is prepared and housed in a bag-shaped exterior member 120 in the same manner as in the second procedure except that a separator 116 coated with a polymer compound on both sides is used. The polymer compound applied to the separator 116 is, for example, a polymer containing vinylidene fluoride as a component (a homopolymer, a copolymer, or a multi-component copolymer). Specific examples of the polymer include binary copolymers containing polyvinylidene fluoride, vinylidene fluoride, or hexafluoropropylene as a component, and ternary copolymers containing vinylidene fluoride, hexafluoropropylene, or chlorotrifluoroethylene as a component. One or two or more other polymer compounds may be used together with the polymer containing vinylidene fluoride as a component. Next, a non-aqueous electrolytic solution is prepared and injected into the exterior member 120, and then the exterior member 120 is sealed at the opening by a heat fusion method or the like. Next, the exterior member 120 is heated while a load is applied to the exterior member 120 to bring the separator 116 into close contact with a positive electrode member 112 and a negative electrode member 114 via the polymer compound. As a result, the polymer compound is impregnated with the non-aqueous electrolytic solution and gels to form an electrolyte layer.

In the third procedure, the swelling of the lithium ion secondary battery is suppressed more than in the first procedure. Furthermore, in the third procedure, the solvent and the monomer that is the raw material of the polymer compound are less likely to remain in the electrolyte layer than in the second procedure, and therefore the process of forming the polymer compound is well controlled. As a result, the positive electrode member 112, the negative electrode member 114, the separator 116, and the electrolyte layer are in sufficiently close contact to each other.

It is also possible to mix the negative electrode active material (silicon) and the precursor of the negative electrode binder (polyamic acid) to obtain a negative electrode mixture. In this case, the mixing ratio is a dry mass ratio of silicon:polyamic acid=80:20. The silicon has an average particle size d₅₀ of 1 ƒm. N-methyl-2-pyrrolidone and dimethylacetamide are used as the solvent for the polyamic acid. Compression molding is performed, and then the negative electrode mixture slurry is heated in a vacuum atmosphere under the conditions of 100° C.×12 hours. As a result, a polyimide that is a negative electrode binder is formed.

Hereinafter, application examples of the present invention will be described.

A battery having the above-described electrode (specifically, the lithium ion secondary battery) can be applied, without particular limitation, to a lithium ion secondary battery used in machines, devices, instruments, apparatus, and systems (colleaions of a plurality of devices and the like) that can be used as a power source for driving/operation or a power storage source for power storage. The lithium ion secondary battery used as a power source may be a main power source (a power source used preferentially) or an auxiliary power source (a power source used in place of or switched from a main power source). In the case that the lithium ion secondary battery is used as an auxiliary power source, the main power source is not limited to a lithium ion secondary battery.

Specific examples of the application of the lithium ion secondary battery include driving of various electronic devices such as video cameras, camcoders, digital still cameras, mobile phones, personal computers, television receivers, various display devices, cordless phones, stereo headphones, music players, portable radios, electronic papers such as electronic books and electronic newspapers, and portable information terminals such as a PDA, and electric devices (such as portable electronic devices); toys; portable living appliances such as electric shavers; lighting fixtures such as interior lights; medical electronic devices such as pacemakers and hearing aids; storage devices such as memory cards; battery packs used, as a removable power source, in personal computers and the like; electric tools such as electric drills and electric saws; power storage systems such as household battery systems for emergency power storage, home energy servers (household power storage devices), and power supply systems; power storage units and backup power sources; electric vehicles such as electric automobiles, electric motorcycles, electric bicycles, and Segway (registered trademark); and electric power/driving force converters for aircraft and ships (specifically, for example, power motors but are not limited to these applications.

The lithium ion secondary battery in the present invention is particularly effectively applied to battery packs, electric vehicles, power storage systems, power supply systems, electric tools, electronic devices, electric devices, and the like. These devices and the like need an excellent battery characteristic, and the performance can be effectively improved if the lithium ion secondary battery of the present invention is used. The battery pack is a power source in which a lithium ion secondary battery is used, and is a so-called assembled battery or the like. The electric vehicle is a vehicle that operates (runs) using a lithium ion secondary battery as a driving power source, and may be an automobile that also has a driving source other than the secondary battery (a hybrid automobile or the like). The power storage system (power supply system) is a system in which a lithium ion secondary battery is used as a power storage source. For example, in a household power storage system (power supply system), electric power is stored in a lithium ion secondary battery that is a power storage source, and therefore household electric products and the like can be used using the electric power. The electric tool is a tool in which a movable part (such as a drill) moves using a lithium ion secondary battery as a power source for driving. The electronic device and the electric device are devices that exhibit various functions using a lithium ion secondary battery as a power source for operation (power supply source).

Hereinafter, some application examples of the lithium ion secondary battery will be specifically described. The configuration of each application example described below is only an example, and the configuration can be changed as appropriate.

The battery pack is a simple battery pack in which one lithium ion secondary battery is used (so-called soft pack), and is mounted on, for example, an electronic device represented by a smartphone. Alternatively, the battery pack includes, for example, an assembled battery including six lithium ion secondary batteries connected so as to be in two-parallel and three-series.

The lithium ion secondary batteries may be connected in series, in parallel, or in both series and parallel.

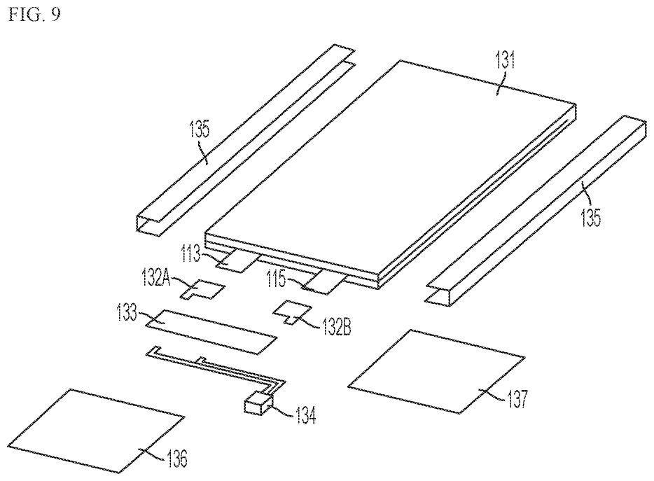

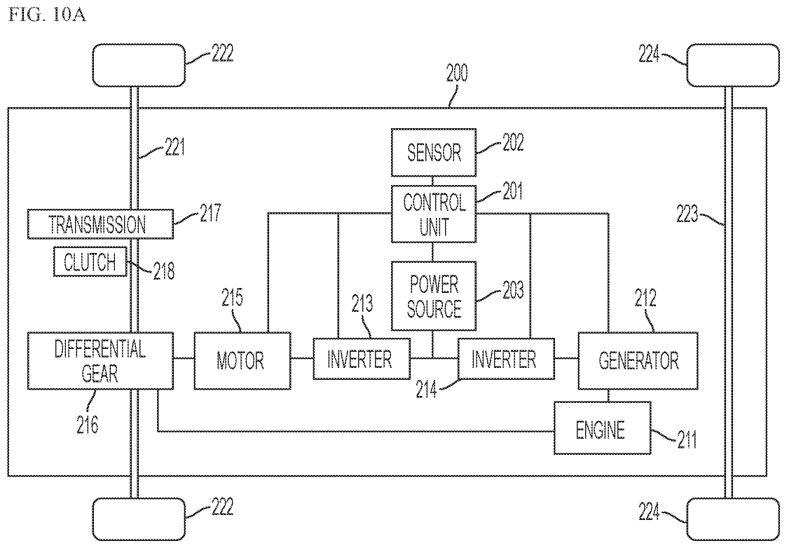

FIG. 9 shows a schematic exploded perspective view of a battery pack in which a unit cell is used. The battery pack is a simple battery pack in which one lithium ion secondary battery is used (so-called soft pack), and is mounted on, for example, an electronic device represented by a smartphone. The battery pack includes, for example, a power source 131 including the lithium ion secondary battery described in Example 5 and a circuit board 133 connected to the power source 131. A positive electrode lead portion 113 and a negative electrode lead portion 115 are attached to the power source 131.

A pair of adhesive tapes 135 are attached to both sides of the power source 131. The circuit board 133 is provided with a protection circuit module (PCM). The circuit board 133 is connected to the positive electrode lead portion 113 via a tab 132A, and is connected to the negative electrode lead portion 115 via a tab 132B. Furthermore, a lead wire with a connector for external connection 134 is connected to the circuit board 133. In the state that the circuit board 133 is connected to the power source 131, the circuit board 133 is protected from above and below by a label 136 and an insulating sheet 137. By attaching the label 136, the circuit board 133 and the insulating sheet 137 are fixed. The circuit board 133 includes a control unit, a switch unit, a PTC, and a temperature detection unit (not shown). The power source 131 can be connected to the outside via a positive electrode terminal and a negative electrode terminal (not shown), and is charged and discharged via the positive electrode terminal and the negative electrode terminal. The temperature detection unit can detect the temperature via a temperature detection terminal (so-called T terminal).

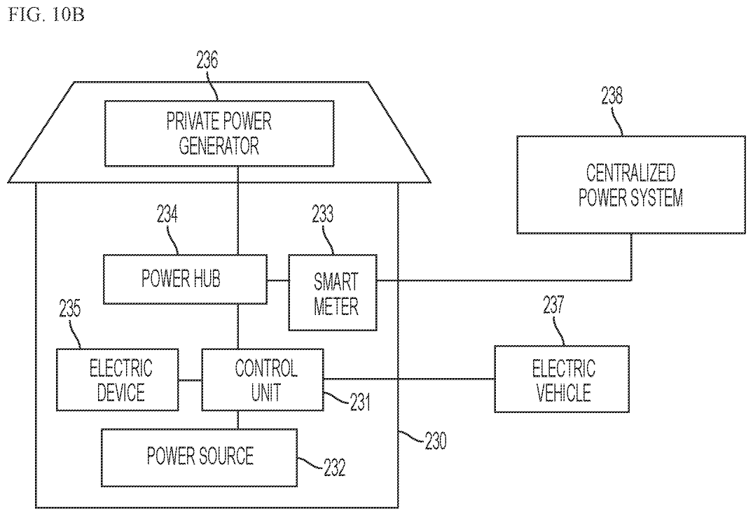

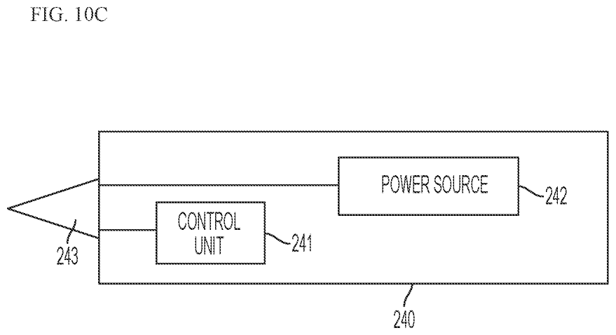

Next, FIG. 10A shows a block diagram showing the configuration of an electric vehicle such as a hybrid automobile that is an example of an electric vehicle. The electric vehicle includes, for example, a control unit 201, a sensor 202, a power source 203, an engine 211, a generator 212, inverters 213 and 214, a motor for driving 215, a differential gear 216, a transmission 217, and a clutch 218 inside a metal housing 200. In addition, the electric vehicle includes, for example, a front wheel drive shaft 221, a front wheel 222, a rear wheel drive shaft 223, and a rear wheel 224 that are connected to the differential gear 216 and the transmission 217.

The electric vehicle can run using, for example, either the engine 211 or the motor 215 as a driving source. The engine 211 is a main power source, and is, for example, a gasoline engine. When the engine 211 is used as a power source, the driving force (rotational force) of the engine 211 is transmitted to the front wheel 222 or the rear wheel 224 via, for example, the differential gear 216, the transmission 217, and the clutch 218 that are a driving unit. The rotational force of the engine 211 is also transmitted to the generator 212, the generator 212 uses the rotational force to generate AC power, the AC power is converted to DC power via the inverter 214, and the DC power is stored in the power source 203. When the motor 215 that is a conversion unit is used as a power source, the power (DC power) supplied from the power source 203 is converted into AC power via the inverter 213, and the motor 215 is driven using the AC power. The driving force (rotational force) from the power converted by the motor 215 is transmitted to the front wheel 222 or the rear wheel 224 via, for example, the differential gear 216, the transmission 217, and the clutch 218 that are a driving unit.

When the electric vehicle decelerates via a braking mechanism (not shown), the resistance force during deceleration is transmitted as a rotational force to the motor 215, and the motor 215 may use the rotational force to generate AC power. The AC power is converted into DC power via the inverter 213, and the DC regenerative power is stored in the power source 203.

The control unit 201 controls the operation of the entire electric vehicle, and includes, for example, a CPU. The power source 203 includes one or two or more lithium ion secondary batteries described in Examples 4 and 5 (not shown). The power source 203 can also be configured to be connected to an external power source and supplied with power from the external power source to store the power. The sensor 202 is used, for example, to control the speed of the engine 211 and to control the opening degree of a throttle valve (not shown) (throttle opening degree). The sensor 202 includes, for example, a speed sensor, an acceleration sensor, and an engine speed sensor.

Although the case where the electric vehicle is a hybrid automobile has been described, the electric vehicle may be a vehicle that operates using only the power source 203 and the motor 215 without using the engine 211 (electric automobile).

Next, FIG. 10B shows a block diagram showing the configuration of a power storage system (power supply system). The power storage system includes, for example, a control unit 231, a power source 232, a smart meter 233, and a power hub 234 inside a house 230 such as a general house or a commercial building.

The power source 232 can be connected to, for example, an electric device (electronic device) 235 installed inside the house 230 and to an electric vehicle 237 parked outside the house 230. The power source 232 can be connected to, for example, a private power generator 236 installed at the house 230 via the power huh 234 and to an external centralized power system 238 via the smart meter 233 and the power hub 234. The electric device (electronic device) 235 includes, for example, one or two or more home appliances. Examples of the home appliance include refrigerators, air conditioners, television receivers, and water heaters. The private power generator 236 includes, for example, a solar power generator and a wind power generator. Examples of the electric vehicle 237 include electric automobiles, hybrid automobiles, electric motorcycles, electric bicycles, and Segway (registered trademark). Examples of the centralized power system 238 include commercial power sources, power generation devices, power grids, smart grids (next generation power grids), thermal power plants, nuclear power plants, hydraulic power plants, and wind power plants, and examples of the power generation device included in the centralized power system 238 include various solar cells, fuel cells, wind power generation devices, micro-hydraulic power generation devices, and geothermal power generation devices, but these examples are not restrictive.

The control unit 231 controls the operation of the entire power storage system (and also controls the usage state of the power source 232), and includes, for example, a CPU. The power source 232 includes one or two or more lithium ion secondary batteries described in Examples 4 and 5 (not shown). The smart meter 233 is, for example, a network-compatible wattmeter installed in the house 230 on the power demand side, and can communicate with the power supply side. Then, the smart meter 233 enables, for example, efficient and stable energy supply by controlling the balance between supply and demand in the house 230 while communicating with the outside.

In this power storage system, for example, power is stored in the power source 232 from the centralized power system 238 being an external power source via the smart meter 233 and the power hub 234, and power is stored in the power source 232 from the private power generator 236 being an independent power source via the power hub 234. The power stored in the power source 232 is supplied to the electric device (electronic device) 235 and the electric vehicle 237 in accordance with the instruction of the control unit 231, so that the electric device (electronic device) 235 can operate and the electric vehicle 237 is rechargeable. That is, the power storage system enables the storage and the supply of power in the house 230 using the power source 232.

The power stored in the power source 232 can be used arbitrarily. Therefore, for example, it is possible to store power in the power source 232 from the centralized power system 238 at midnight when the electricity charge is low, and use the power stored in the power source 232 during the daytime when the electricity charge is high.

The power storage system described above may be installed per one house (one household) or per a plurality of houses (a plurality of households).

Next, FIG. 10C shows a block diagram showing the configuration of an electric tool. The electric tool is, for example, an electric drill, and includes a control unit 241 and a power source 242 inside a tool body 240 prepared from a plastic material or the like. For example, a drill portion 243 that is a movable part is rotatably attached to the tool body 240. The control unit 241 controls the operation of the entire electric tool (and also controls the usage state of the power source 242), and includes, for example, a CPU. The power source 242 includes one or two or more lithium ion secondary batteries described in Examples 4 and 5 (not shown). The control unit 241 supplies power from the power source 242 to the drill portion 243 in response to the operation of an operation switch (not shown).

The present invention has been described above based on the preferable examples, but the present invention is not limited to these examples, and various modifications are possible. The configuration and the structure of the laminated structure, the configuration and the structure of the roll press device, and the method for manufacturing the laminated structure described in Examples are exemplary, and can be changed as appropriate. In Examples, an example has been described in which the laminated structure enters the press roll from the first A end and second A end side of the laminated structure, but a form may be employed in which the laminated structure enters the press roll from the first B end and second B end side of the laminated structure. It is also possible to combine the positive electrode member or the negative electrode member (the electrode member) having the laminated structure described in Examples 1 to 3 and a positive electrode member or a negative electrode member (an electrode member) having a configuration and a structure other than those of the positive electrode member or the negative electrode member described in Examples 1 to 3 to obtain an electrode structure. The electrode structure may be in a stacked state as well as in a wound state.

The secondary battery in the present invention can be used as a power source for driving or as an auxiliary power source for notebook personal computers, battery packs used, as a removable power source, in personal computers and the like, various display devices, portable information terminals such as a personal digital assistant (PD), mobile phones, smartphones, cordless phone master devices, cordless phone slave devices, video movies (video cameras and camcorders), digital still cameras, electronic papers such as electronic books and electronic newspapers, electronic dictionaries, music players, portable music players, radios, portable radios, headphones, stereo headphones, game consoles, wearable devices (such as smart watches, wristbands, smart eyeglasses, medical devices, and health care products), navigation systems, memory cards, heart pacemakers, hearing aids, electric tools, electric shavers, refrigerators, air conditioners, television receivers, stereos, water heaters, microwave ovens, dishwashers, washing machines, dryers, lighting fixtures such as interior lights, various electric devices (such as portable electronic devices), toys, medical devices, robots, IoT devices, IoT terminals, road conditioners, traffic lights, railroad vehicles, golf carts, electric carts, electric automobiles (such as hybrid automobiles), and the like. Furthermore, the secondary battery can be mounted on, for example, a power source for power storage for buildings such as houses or power generation facilities, or can be used to supply power to these buildings or facilities. In an electric automobile, a converter that is supplied with power to convert the power into driving force is generally a motor. Examples of the control device (control unit) that processes the information relating to the vehicle control include control devices that display the secondary battery remaining amount based on the information on the secondary battery remaining amount. Furthermore, the secondary battery can also be used in a power storage device in a so-called smart grid. Such a power storage device can not only supply power but also store power by being supplied with power from another power source. As another power source, for example, thermal power generation, nuclear power generation, hydraulic power generation, solar cells, wind power generation, geothermal power generation, fuel cells (such as biofuel cells), and the like can be used.

A form is possible in which the electrode of the present invention is used in a secondary battery and in a secondary battery in a battery pack having a control means (control unit) that performs the control relating the secondary battery. Furthermore, a form is possible in which the electrode of the present invention is used in a secondary battery in an electronic device that is supplied with power from the secondary battery.

A form is possible in which the electrode of the present invention is used in a secondary battery in an electric vehicle having a converter that is supplied with power from the secondary battery to convert the power into the driving force of the vehicle, and having a control device (control unit) that processes the information relating to the vehicle control based on the information about the secondary battery. In this electric vehicle, the converter is typically supplied with power from the secondary battery to drive the motor and generate driving force. Regenerative energy can also be used to drive the motor. The control device processes the information relating to the vehicle control based on, for example, the secondary battery remaining amount. Examples of the electric vehicle include electric automobiles, electric motorcycles, electric bicycles, railroad vehicles, and so-called hybrid automobiles.

The secondary battery can also be used in a power storage device in a so-called smart grid. Such a power storage device can not only supply power but also store power by being supplied with power from another power source. A form is possible in which the electrode of the present invention is used in the secondary battery in the power storage device.

As another power source, for example, thermal power generation, nuclear power generation, hydraulic power generation, solar cells, wind power generation, geothermal power generation, fuel cells (such as biofuel cells), and the like can be used.

A form is possible in which the electrode of the present invention is used in a secondary battery in a power storage system (or a power supply system) configured to be supplied with power from the secondary battery and/or to supply power from the power source to the secondary battery. This power storage system may be any power storage system as long as it uses electric power, and examples of the power storage system include simple electric power devices. Examples of the power storage system include smart grids, household energy management systems (HEMSs), and vehicles, and the power storage system can also store power.

A form is possible in which the electrode of the present invention is used in a secondary battery in a power source for power storage that has a secondary battery and is configured to be connected to an electronic device that is supplied with power. The power source for power storage can be used for any application, and can be basically used for any power storage system, power supply system, or power device, and can be used in, for example, a smart grid.

### EXAMPLES

Hereinafter, the method for manufacturing a battery electrode according to the present invention and the battery electrode obtained by the method will be described.

### Comparative Example

The method for manufacturing a battery electrode 100′ (conventional) was performed through the following process.

First, using a coating device, one main side of a metal foil as a current collector 10′ was intermittently coated with an electrode material, and another main side was intermittently coated with an electrode material. At this time, the interval of the electrode material applied to one main side of the metal foil and the interval of the electrode material applied to another main side of the metal foil were provided so as not to overlap each other. As a result, a precursor of the electrode 100′ was formed that included a double-sided coating area in which both sides of the current collector 10′ were coated with electrode material layers 20′ and 30′ and included a single-sided coating area adjacent to the double-sided coating area each other, the single-sided coating area in which one side of the current collector 10′ was coated with the electrode material layer 20′.

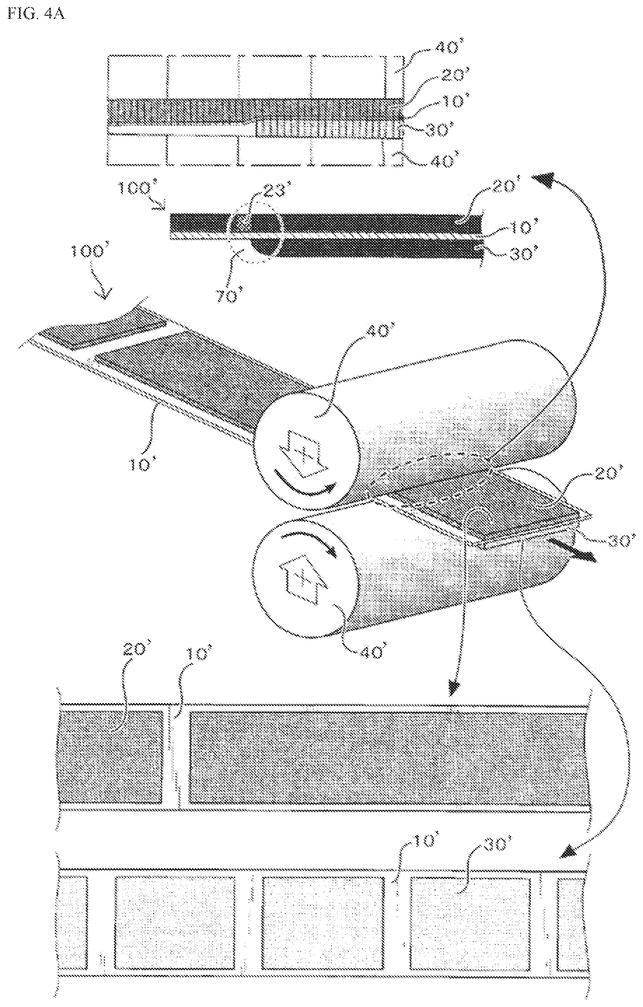

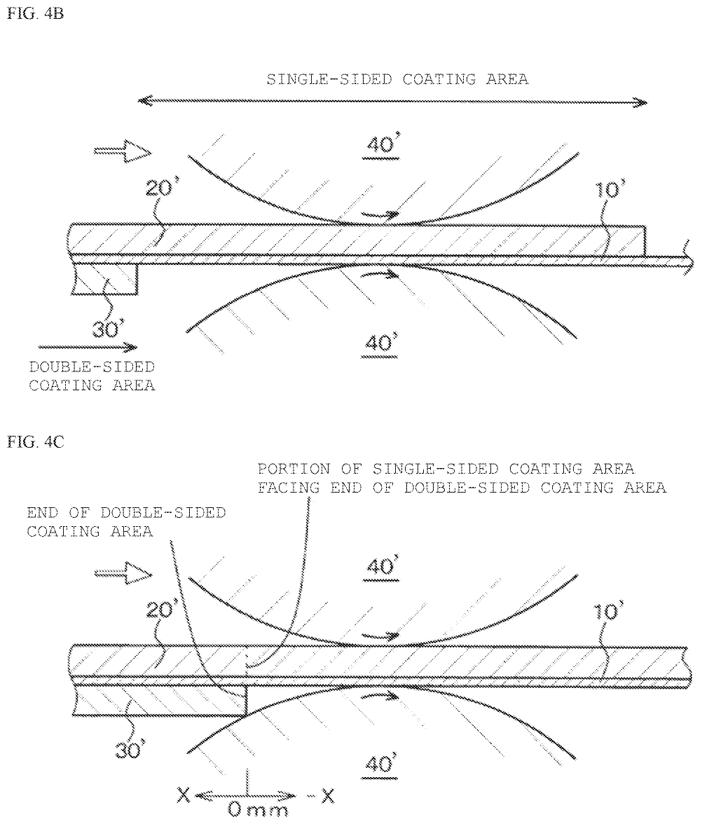

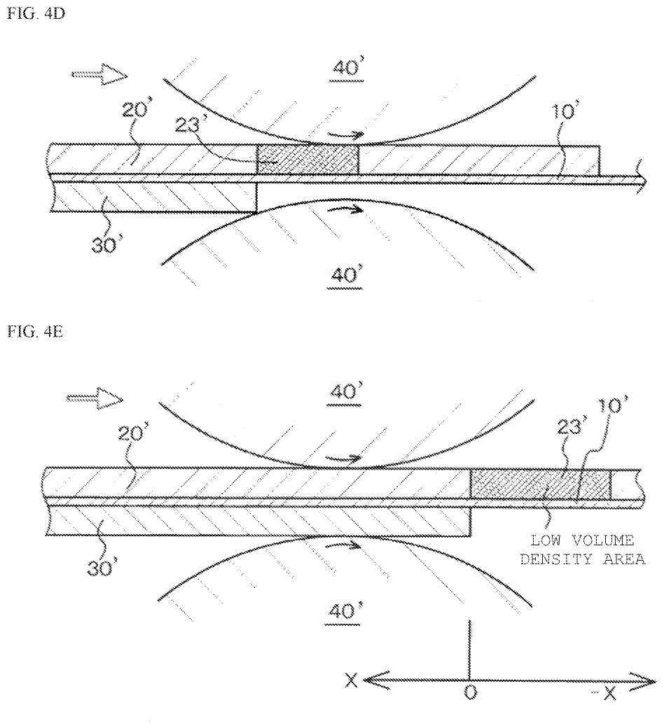

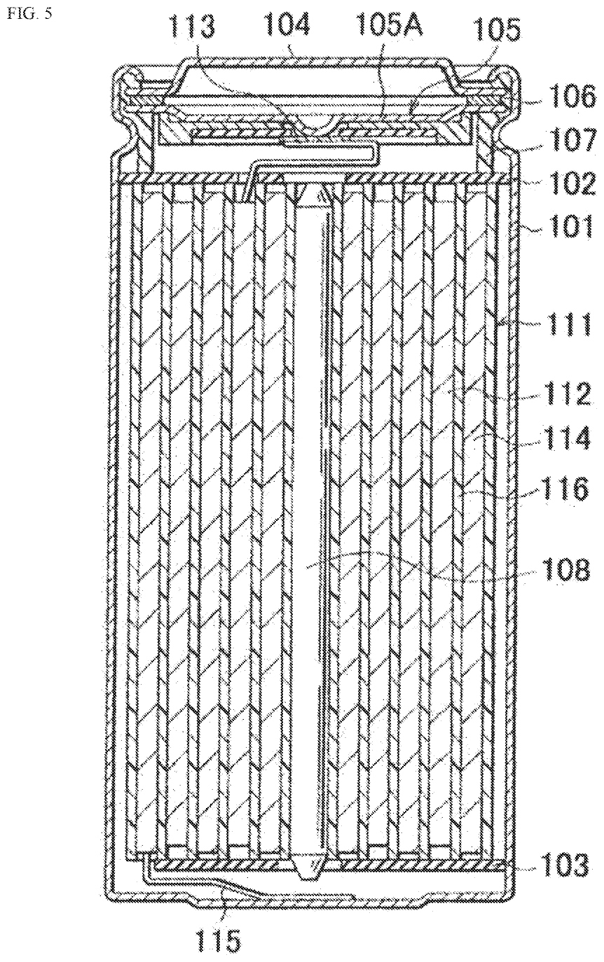

Next, from the viewpoint of increasing the density of the electrode material layer included in the formed precursor of the battery electrode 100′, the precursor of the battery electrode 100′ was pressurized using a press roll 40′ while the precursor was continuously moved in one direction between a pair of press rolls 40′ facing each other (see the upper part of FIG. 1 and FIGS. 4A to 4E). After a lapse of a predetermined time, the battery electrode 100′ was cooled to obtain the battery electrode 100′ finally.

When the battery electrode 100′ was obtained, the set values for the following items were as follows.

Radius of pair of press rolls 40′: 0.375 m(0.25 m˜0.50 m)

Thickness of current collector (metal foil) 10′: 6 μm (4 μm to 20 μm)

Thickness of electrode material layer 20′: 90 μm (50 μm to 125 μm)

Thickness of electrode material layer 30′: 90 μm

Positive electrode

Area density 30 mg/cm₂˜50 mg/cm₂

Volume density 3.9 g/cm₃˜4.3 g/cm₃

Linear pressure during press 110 kN/cm˜40 kN/cm

Negative electrode

Area density 10 mg/cm₂˜30 mg/cm₂

Volume density 3.9 g/cm₃˜4.3 g/cm₃

Linear pressure during press 6 kN/cm˜30 kN/cm

Here, the current collector 10′ was punched into a dumbbell shape, then the obtained dumbbell-shaped piece was subjected to a tensile test at room temperature (23° C.) using a universal tensile test device manufactured by Instron with a chuck distance of 50 mm at a tensile speed of 1 mm/min, and the Young's modulus was calculated from the tangent of the rising part of the obtained load-elongation curve. The Young's modulus of the current collector 10′ that was a constituent element of the obtained battery electrode 100′ was 74 Gpa. That is, the rigidity of the current collector 10′ was relatively high. Therefore, although the electrode material layer 20′ was located on the upper side of the current collector 10′ in the single-sided coating area located at the boundary portion 70′, and the weight of the electrode material layer 20′ acted on the current collector 10′, the heat-treated current collector 10′ in the single-sided coating area located at the boundary portion 70′ was curved downward to a small extent.

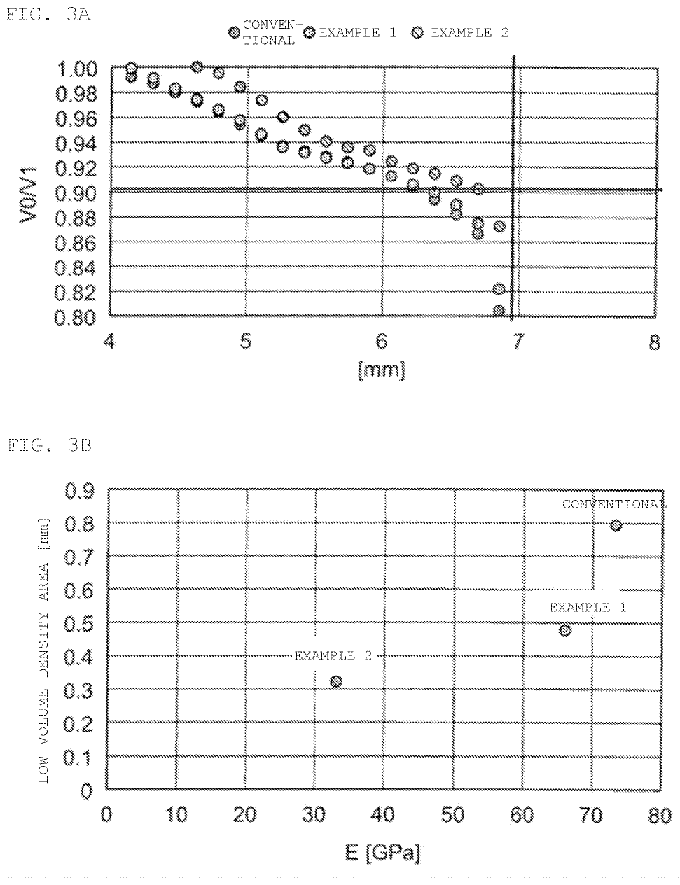

Therefore, when the precursor of the electrode 100′ was pressurized using the pair of press rolls 40′, the range was small in which the current collector 10′ in the single-sided coating area located at the boundary portion 70′ and the press roll 40′ were capable of being in contact with each other. As a result, it was not easy to pressurize the current collector and the electrode material layer in the single-sided coating area located at the boundary portion using the pair of press rolls facing each other. Therefore, the range of a low volume density area 23′ of the electrode material layer 20′ in the single-sided coating area located at the boundary portion 70′ was relatively large, and the width of the range was about 0.8 mm. Specifically, in the low volume density area 23′ (width: about 0.8 mm), the ratio of the volume density of the electrode material layer 20′ located at the boundary portion 70′ (A) to the volume density of the electrode material layer 20′ located at the portion other than the boundary portion 70′ (B) (A/B) was less than 0.9 (see FIG. 3).

### Example 1

The method for manufacturing a battery electrode 100 was performed through the following process.

First, using a coating device, one main side of a metal foil as a current collector 10 was intermittently coated with an electrode material, and another main side was intermittently coated with an electrode material. At this time, the interval of the electrode material applied. to one main side of the metal foil and the interval of the electrode material applied to another main side of the metal foil were provided so as not to overlap each other. As a result, a precursor of the electrode 100 was formed that included a double-sided coating area in which both sides of the current collector 10 were coated with electrode material layers 20 and 30 and included a single-sided coating area adjacent to the double-sided coating area, the single-sided coating area in which one side of the current collector 10 was coated with the electrode material layer 20.

In Example 1, in a different manner from in Comparative Example described above, after forming the precursor of the electrode body 100, the current collector 10 located at the boundary portion 70 between the double-sided coating area and the single-sided coating area was subjected to a heat treatment using a high-frequency induction heating device 80 (heat treatment temperature: 200 degrees) before pressurizing the precursor. By such a heat treatment, the local portion of the current collector 10 located at the boundary portion 70 was softened because the thermal energy was applied to the portion. The Young's modulus of the softened portion of the current collector was 66 Gpa. That is, the rigidity of the current collector 10 located at the boundary portion 70 was relatively low. Therefore, because the electrode material layer 20 was located on the upper side of the current collector 10 in the single-sided coating area located at the boundary portion 70, and the weight of the electrode material layer 20 acted on the current collector 10, the heat-treated current collector 10 in the single-sided coating area located at the boundary portion 70 was curved downward to a greater extent than in Comparative Example.

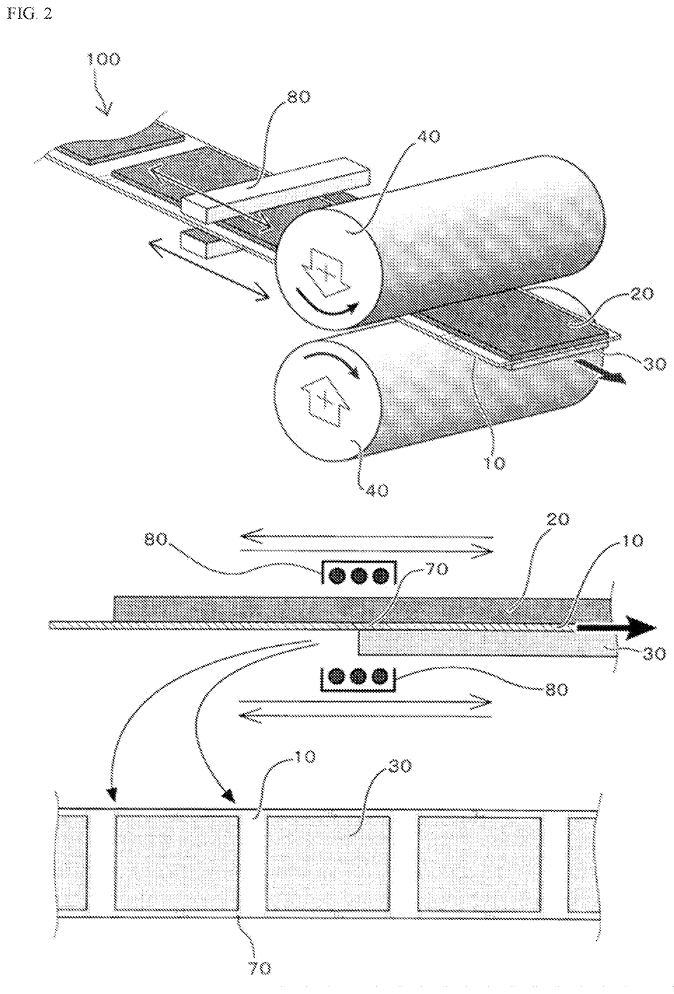

In this state, after subjecting the current collector located at the boundary portion 70 to the heat treatment, the precursor of the battery electrode 100 was pressurized using a press roll 40 while the precursor was continuously moved in one direction between a pair of press rolls 40 facing each other front the viewpoint of increasing the density of the electrode material layer included in the precursor of the battery electrode 100 (see the lower part of FIG. 1 and FIG. 2). After a lapse of a predetermined time, the battery electrode 100 was cooled to obtain the battery electrode 100 finally.

The set values for obtaining the battery electrode 100 are the same as those described in Comparative Example described above. Therefore, the description will be omitted in order to avoid duplication of description.

As described above, the heat-treated current collector 10 in the single-sided coating area located at the boundary portion 70 was curved downward to a greater extent than in Comparative Example. Therefore, after pressurizing the precursor of the electrode 100 using the pair of press rolls 40, the range in which the current collector 10 in the single-sided coating area located at the boundary portion 70 and the press roll 40 were capable of being in contact with each other was larger than in Comparative Example. As a result, it was easier than in Comparative Example to pressurize the current collector and the electrode material layer in the single-sided coating area located at the boundary portion using the pair of press rolls facing each other. Therefore, the range of a low volume density area 23 of the electrode material layer 20 in the single-sided coating area located at the boundary portion 70 was smaller than in Comparative Example, and the width of the range was about 0.5 mm. Specifically, in the low volume density area 23 (width: about 0.5 mm), the ratio of the volume density of the electrode material layer 20 located at the boundary portion 70 (A) to the volume density of the electrode material layer 20 located at the portion other than the boundary portion 70 (B) (A/B) was less than 0.9 (see FIG. 3). As a result, it was possible to reduce the range of the low volume density area in Example 1 to be smaller than in Comparative Example. Then, in the current collector 10 that is a constituent element of the finally obtained battery electrode 100, the Young's modulus of the current collector 10 located at the boundary portion 70 between the double-sided coating area and the single-sided coating area was reduced to he about 10% lower than the Young's modulus of the current collector 10 located at the portion other than the boundary portion 70.

### Example 2

The method for manufacturing a battery electrode 100 was performed through the following process.

First, in the same manner as in Example 1, a precursor of the electrode 100 was formed that included a double-sided coating area in which both sides of a current collector 10 were coated with electrode material layers 20 and 30 and included a single-sided coating area adjacent to the double-sided coating area each other, the single-sided coating area in which one side of the current collector 10 was coated with the electrode material layer 20.

In Example 2, in a different manner from in Example 1 described above, after forming the precursor of the electrode 100, the current collector 10 located at the boundary portion 70 between the double-sided coating area and the single-sided coating area was subjected to a heat treatment using a high-frequency induction heating device 80 by applying larger thermal energy (heat treatment temperature: >200 degrees) before pressurizing the precursor. By such a heat treatment, the local portion of the current collector 10 located at the boundary portion 70 was softened more than in Example 1 because the thermal energy was applied to the portion. The Young's modulus of the softened portion of the current collector was 33 Gpa. That is, the rigidity of the current collector 10 located at the boundary portion 70 was lower than in Example 1. Therefore, because the electrode material layer 20 was located on the upper side of the current collector 10 in the single-sided coating area located at the boundary portion 70, and the weight of the electrode material layer 20 acted on the current collector 10, the heat-treated current collector 10 in the single-sided coating area located at the boundary portion 70 was curved downward to a greater extent than in Example 1.

Next, after subjecting the current collector located at the boundary portion 70 to the heat treatment, the precursor of the electrode 100 was pressurized with a pair of press rolls 40 (see the lower part of FIG. 1 and FIG. 2). After a lapse of a predetermined time, the battery electrode 100 was cooled to obtain the battery electrode 100 finally.

The set values for obtaining the battery electrode 100 are the same as those described in Comparative Example described above. Therefore, the description will be omitted in order to avoid duplication of description.

As described above, the heat-treated current collector 10 in the single-sided coating area located at the boundary portion 70 was curved downward to a greater extent than in Example 1. Therefore, after pressurizing the precursor of the electrode 100 using the pair of press rolls 40, the range in which the current collector 10 in the single-sided coating area located at the boundary portion 70 and the press roll 40 were capable of being in contact with each other was larger than in Example 1. As a result, it was easier than in Example 1 to pressurize the current collector and the electrode material layer in the single-sided coating area located at the boundary portion using the pair of press rolls facing each other. Therefore, the range of a low volume density area 23 of the electrode material layer 20 in the single-sided. coating area located at the boundary portion 70 was smaller than in Example 1, and the width of the range was about 0.3 mm. Specifically, in the low volume density area 23 (width: about 0.3 mm), the ratio of the volume density of the electrode material layer 20 located at the boundary portion 70 (A) to the volume density of the electrode material layer 20 located at the portion other than the boundary portion 70 (B) (A/B) was less than 0.9 (see FIG. 3). As a result, it was possible to reduce the range of the low volume density area in Example 2 to be smaller than in Example 1. Then, in the current collector 10 that is a constituent element of the finally obtained battery electrode 100, the Young's modulus of the current collector 10 located at the boundary portion 70 between the double-sided coating area and the single-sided coating area was reduced to be 50% or more lower than the Young's modulus of the current collector 10 located at the portion other than the boundary portion 70.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method for manufacturing a battery electrode, the method comprising steps of:
forming a precursor of the battery electrode including a double-sided coating area in which both sides of a current collector are coated with an electrode material layer and a single-sided coating area adjacent to the double-sided coating area, wherein the single-sided coating area includes a main side of the current collector that is coated with the electrode material laver;
subjecting the current collector located at a boundary portion between the double-sided coating area and the single-sided coating area to a heat treatment locally; and
pressurizing the precursor of the battery electrode.

2. The method according to claim 1, wherein the current collector located at the boundary portion is locally softened by the heat treatment.

3. The method according to claim 1, wherein the current collector located at the boundary portion has a curved area increased by the heat treatment to be larger than the current collector that is not subjected to the heat treatment.

4. The method according to claim 1,
wherein the precursor of the battery electrode is pressurized using a pair of press rolls positioned to sandwich the precursor, and
a spatial area formed between the current collector located at the boundary portion and the press roll directly facing the current collector has a size reduced by the heat treatment to he smaller than the current collector that is not subjected to the heat treatment.

5. The method according to claim 1, wherein a Young's modulus of the current collector located at the boundary portion by the heat treatment is lower than a Young's modulus of the current collector located at a portion other than the boundary portion.

6. The method according to claim 5, wherein the Young's modulus of the current collector located at the boundary portion is 50% or more lower than the Young's modulus of the current collector located at the portion other than the boundary portion.

7. The method according to claim 1, wherein the heat treatment is performed, as a non-contact heat treatment, without contact with the current collector located at the boundary portion and the electrode material layer.

8. The method according to claim 7, wherein the non-contact heat treatment is performed using a high-frequency induction heating device.

9. The method according to claim 8, wherein the high-frequency induction heating device is driven when the high-frequency induction heating device faces the current collector located at the boundary portion.

10. The method according to claim 1, wherein after pressurizing the precursor of the battery electrode, a ratio of a volume density of the electrode material layer located at the boundary portion (A) to a volume density of the electrode material layer located at the portion other than the boundary portion (B) is from 0.9 to 1.0.

11. The method according to claim 1, wherein after pressurizing the precursor of the battery electrode, the electrode material layer located at the boundary portion has a low volume density area with a size lower than the current collector that is not subjected to the heat treatment.

12. A battery electrode comprising:
a double-sided coating area including a current collector and an electrode material layer with which both sides of the current collector are coated; and
a single-sided coating area adjacent to the double-sided coating area, wherein the single-sided coating area includes the current collector and the electrode material layer with which one side of the current collector is coated,
wherein the current collector located at a boundary portion between the double-sided coating area and the single-sided coating area has a Young's modulus lower than a Young's modulus of the current collector located at a portion other than the boundary portion.

13. The battery electrode according to claim 12, wherein the Young's modulus of the current collector located at the boundary portion is 50% or more lower than the Young's modulus of the current collector located at the portion other than the boundary portion.

14. The battery electrode according to claim 12, wherein a ratio of a volume density of the electrode material layer located at the boundary portion (A) to a volume density of the electrode material layer located at the portion other than the boundary portion (B) is from 0.9 to 1.0.

15. The battery electrode according to claim 13, wherein a ratio of a volume density of the electrode material layer located at the boundary portion (A) to a volume density of the electrode material layer located at the portion other than the boundary portion (B) is from 0.9 to 1.0.
